(19) United States
(12) Patent Application Publication
(10) Pub. No.: US 2010/0008200 A1
(43) Pub. Date: Jan. 14, 2010

(54) OPTICAL DISC APPARATUS AND SIGNAL RECORDING SURFACE DETECTING METHOD

(75) Inventor: Koichiro Ogihara, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/497,951

(22) Filed: Jul. 6, 2009

(30) Foreign Application Priority Data
Jul. 9, 2008 (JP) 2008-179257

(51) Int. Cl. G11B 7/00

(52) U.S. Cl. 369/53.2; 369/112.23; G9B/7

(57) ABSTRACT

An optical disc apparatus includes: an objective lens that condenses a first light beam, which is emitted from a light source and corresponds to a first optical disc, and that illuminates the first light beam to an unknown disc whose type is unknown; a driving section that drives the objective lens in a focus direction approaching or becoming distant from the unknown disc; a rotation section that rotates the unknown disc; a signal processing section that generates a first reproduction signal indicating a total amount of a first returning light beam generated by reflection of the first light beam from the unknown disc; and a detecting section that detects a first signal recording surface, which corresponds to the first optical disc, from the unknown disc on the basis of the first reproduction signal.

### BACKGROUND OF THE INVENTION

1. Field of the Invention

The present invention relates to an optical disc apparatus and a signal recording surface detecting method and is suitably applied to an optical disc apparatus which supports a plurality of types of optical discs.

2. Description of the Related Art

Known optical disc apparatuses that record information on an optical disc as recording media by illuminating a light beam to the optical disc and reproduce the information from the optical disc have come into wide use.

Among the optical disc apparatuses, one that supports both an optical disc based on a CD (compact disc) method, in which a light beam with a wavelength of about 780 [nm] is used, and an optical disc based on a DVD (digital versatile disc) method, in which a light beam with a wavelength of about 660 [nm] is used, has also been proposed.

In addition, both an optical disc based on the CD method and an optical disc based on the DVD method are common in that the external diameter is about 120 [mm] and the thickness is about 1.2 [mm]. However, distances from top surfaces of the optical discs to recording layers in which information is recorded, so-called thicknesses of cover layers are different from each other. That is, the thickness of a cover layer is about 1.2 [mm] in the CD method and about 0.6 [mm] in the DVD method.

In the optical disc apparatuses, a technique of recognizing the distance from a top surface of an optical disc to a recording layer on the basis of a detection result of a returning light beam generated by illumination of a light beam from the optical disc, for example, when the optical disc is loaded and of determining the type of the optical disc, such as the CD method or the DVD method, from the distance while focusing the light beam on the recording layer correctly is used (for example, refer to JP-A-2003-157545 (FIG. 2)).

As shown in FIGS. 1A and 1B, an optical disc apparatus first keeps, for example, an objective lens away from an optical disc, and then brings the objective lens close to the optical disc at a fixed moving speed while illuminating a light beam (hereinafter, these operations are referred to as a search operation) and generates a focus error signal SFE and a pull-in signal SPI from the amount of reflected light.

Then, the optical disc apparatus detects a top surface and a signal recording surface of the optical disc from the focus error signal SFE and the pull-in signal SPI and calculates a distance between the top surface and the signal recording surface, that is, the thickness of the cover layer from a difference of time at which the top surface and the signal recording surface were detected, thereby determining the type of the optical disc.

### SUMMARY OF THE INVENTION

On the other hand, in order to meet a request to increase the capacity of an optical disc and the like, the Blu-ray Disc (registered trademark; hereinafter, referred to as BD) method using a light beam with a wavelength of about 405 [mm] has also been proposed recently. In the BD method, it is defined that the numerical aperture of an objective lens is set to 0.85.

Accordingly, it is considered to use a wavelength selective multifocal lens as an objective lens OL so that the optical disc apparatus can support an optical disc based on the BD method as well as optical discs based on the CD method and the DVD method.

The objective lens OL is designed such that focal points are formed on a plurality of focusing positions and a change to the numerical aperture corresponding to the type of an optical disc 100 is made when a light beam with a wavelength corresponding to the type of the optical disc 100 is incident.

That is, as shown in FIGS. 1A and 1B, for example, when a CD light beam Lc is incident on the objective lens OL, a condensing point is also formed at a position (hereinafter, referred to as an improper position) other than a focal point Fc for CD corresponding to the wavelength of the CD light beam Lc because the objective lens OL acts as a wavelength selective multifocal lens. Moreover, in the optical disc apparatus, a light beam (hereinafter, referred to as unused light) U which forms a condensing point at the improper position is not used. In addition, since the condensing point of the unused light U is spaced apart from the optical disc 100, the unused light U does not cause a serious problem at the time of reproduction and recording of information.

However, since the optical disc apparatus detects a disc surface and a signal recording surface by illuminating the CD light beam Lc to the optical disc 100 whose type is unknown (hereinafter, referred to as an unknown disc 100x) while moving the objective lens OL in a focus direction in media type determination processing, the condensing point of the unused light U is formed on the unknown disc 100x.

That is, when illuminating the CD light beam Lc to the unknown disc 100x, the optical disc apparatus detects a surface reflection pattern PSr, which indicates that the CD light beam Lc has been reflected by the disc surface, and a recording surface reflection pattern PRr, which indicates that the CD light beam Lc has been reflected by the signal recording surface, from the pull-in signal SPI, for example.

Furthermore, the optical disc apparatus detects the CD light beam Lc, which has been reflected by the disc surface, and the unused light U, which has been reflected by the disc surface, as a surface fake pattern PSf (PSf1 to PSf3) from the pull-in signal SPI which becomes the total amount of a returning light beam.

In the objective lens OL, it is necessary to largely change the numerical aperture from 0.45 corresponding to the CD media 100c to 0.85 corresponding to the BD media 100b. For this reason, the light use efficiency tends to be lowered. For example, in the objective lens OL, since the numerical aperture is small, particularly the light use efficiency of the CD light beam Lc becomes low as about 10% to 20%.

That is, in the optical disc apparatus 1, in case of emitting the CD light beam Lc as a light beam, about 80% to 90% of the CD light beam Lc incident on the objective lens OL become the unused light U. For this reason, in case of illuminating the CD light beam Lc to the unknown disc 100x, the optical disc apparatus 1 causes the surface fake pattern PSf1 with large amplitude to appear between the surface reflection pattern PSr and the recording surface reflection pattern PRr in the pull-in signal SPI, for example.

In addition, an actuator for moving the objective lens OL changes the moving speed, at which the objective lens OL is moved, due to an individual difference of sensitivity, a temperature change, a temporal sensitivity change, and the like. Accordingly, a difference of time itself at which the surface reflection pattern PSr and the recording surface reflection pattern PRr are detected changes.

In such a case, it becomes difficult for the optical disc apparatus to distinguish a returning light beam obtained by a light beam having a desired focal point from a returning light beam obtained by the unused light U. As a result, a problem that a signal recording surface cannot be correctly detected has occurred.

In view of the above, it is desirable to propose an optical disc apparatus and a signal recording surface detecting method capable of detecting a signal recording surface of an optical disc correctly.

According to an embodiment of the present invention, there is provided an optical disc apparatus including: an objective lens that condenses a first light beam, which is emitted from a light source and corresponds to a first optical disc, and that illuminates the first light beam to an unknown disc whose type is unknown; a driving section that drives the objective lens in a focus direction approaching or becoming distant from the unknown disc; a rotation section that rotates the unknown disc; a signal processing section that generates a first reproduction signal indicating a total amount of a first returning light beam generated by reflection of the first light beam from the unknown disc; and a detecting section that detects a first signal recording surface, which corresponds to the first optical disc, from the unknown disc on the basis of the first reproduction signal.

Therefore, in the optical disc apparatus, the first signal recording surface can be detected from the unknown disc on the basis of a recording mark formed on the first signal recording surface.

Furthermore, according to another embodiment of the present invention, there is provided a signal recording surface detecting method including the steps of: performing focus search of rotating an unknown disc whose type is unknown, condensing a first light beam corresponding to a first optical disc and illuminating the first light beam to the unknown disc by the objective lens, and driving the objective lens in a focus direction approaching or becoming distant from the unknown disc; performing signal processing for generating a first reproduction signal indicating a total amount of a first returning light beam generated by reflection of the light beam from the unknown disc; and detecting a first signal recording surface, which corresponds to the first optical disc, from the unknown disc on the basis of the first reproduction signal.

Therefore, in the signal recording surface detecting method, the first signal recording surface can be detected from the unknown disc on the basis of a recording mark formed on the first signal recording surface.

Furthermore, according to still another embodiment of the present invention, there is provided an optical disc apparatus including: an objective lens that condenses a light beam emitted from a light source and illuminates the light beam to an optical disc; a driving section that drives the objective lens in a focus direction approaching or becoming distant from the optical disc; a rotation section that rotates the optical disc; a signal processing section that generates a reproduction signal indicating a total amount of a returning light beam generated by reflection of the light beam from the optical disc; and a detecting section that detects a signal recording surface from the optical disc on the basis of the reproduction signal.

Therefore, in the optical disc apparatus, the signal recording surface can be detected from the optical disc on the basis of a recording mark formed on the signal recording surface.

Furthermore, according to still another embodiment of the present invention, there is provided a signal recording surface detecting method including the steps of: performing focus search of rotating an optical disc, condensing a light beam emitted from a light source and illuminating the light beam to the optical disc, and changing a focal point of the light beam in a focus direction approaching or becoming distant from the optical disc; performing signal processing for generating a reproduction signal indicating a total amount of a returning light beam generated by reflection of the light beam from the optical disc; and detecting a signal recording surface from the optical disc on the basis of the reproduction signal.

Therefore, in the signal recording surface detecting method, the signal recording surface can be detected from the optical disc on the basis of a recording mark formed on the signal recording surface.

According to the embodiments of the present invention, the first signal recording surface can be detected from the unknown disc on the basis of a recording mark formed on the first signal recording surface. In this way, it is possible to realize an optical disc apparatus and a signal recording surface detecting method capable of detecting a signal recording surface of an optical disc correctly.

According to the embodiments of the present invention, the signal recording surface can be detected from the optical disc on the basis of a recording mark formed on the signal recording surface. In this way, it is possible to realize an optical disc apparatus and a signal recording surface detecting method capable of detecting a signal recording surface of an optical disc correctly.

### BRIEF DESCRIPTION OF THE DRAWINGS

FIGS. 1A and 1B are schematic views for explaining a case where a CD light beam is illuminated to a CD media;

FIGS. 2A to 2D are schematic views for explaining the relationship between a recording mark and binary reproduction data;

FIGS. 3A to 3B are schematic views illustrating the size of a recording mark in each optical disc;

FIG. 4 is a schematic view illustrating the configuration of an optical disc apparatus;

FIGS. 5A and 5B are schematic views illustrating a reproduction signal and an S-shaped signal (1);

FIG. 6 is a schematic view illustrating a reproduction signal and an S-shaped signal (2);

FIG. 7 is a schematic view illustrating the configuration of a signal processing unit;

FIGS. 8A to 8G are schematic views for explaining various signals near a signal recording surface;

FIGS. 9A to 9G are schematic views for explaining various signals in a search operation;

FIG. 10 is a schematic view for explaining the frequency of appearance of a data edge distance in a BD media;

FIG. 11 is a schematic view for explaining the frequency of appearance of a data edge distance in a DVD media;

FIG. 12 is a schematic view for explaining the frequency of appearance of a data edge distance in a CD media;

FIGS. 13A and 13B are schematic views illustrating the comparison of data edge distances in respective optical discs;

FIG. 14 is a schematic view illustrating the configuration of an FOK_RF detecting section in a first embodiment;

FIG. 15 is a schematic view for explaining measurement of the data edge distance;

FIG. 16 is a flow chart illustrating disk determination and focus control start procedures;

FIG. 17 is a flow chart illustrating a disc determination procedure by counting of a target edge length;

FIG. 18 is a schematic view illustrating the configuration of an FOK_RF detecting section in a second embodiment;

FIG. 19 is a flow chart illustrating a disc determination procedure by average frequency measurement;

FIGS. 20A and 20B are schematic views for explaining the comparison of data edge distances at the BD rotation number;

FIG. 21 is a flow chart illustrating a media type determination procedure; and

FIG. 22 is a flowchart illustrating a focus control start procedure.

### DESCRIPTION OF THE PREFERRED EMBODIMENTS

Hereinafter, an embodiment of the present invention will be described with reference to the accompanying drawings.

### (1) Principle of Embodiments of the Present Invention

In an optical disc 100, it is general that a recording mark RM is formed by providing unevenness on a signal recording surface or by locally reducing the reflectance of the signal recording surface. Moreover, in the optical disc 100, when a light beam is illuminated to the recording mark RM, the light amount of returning light beams from the optical disc 100 can be reduced due to scattering caused by diffraction, a decrease in reflectance, and the like compared with a case where a light beam is illuminated to a place in which the recording mark RM is not formed.

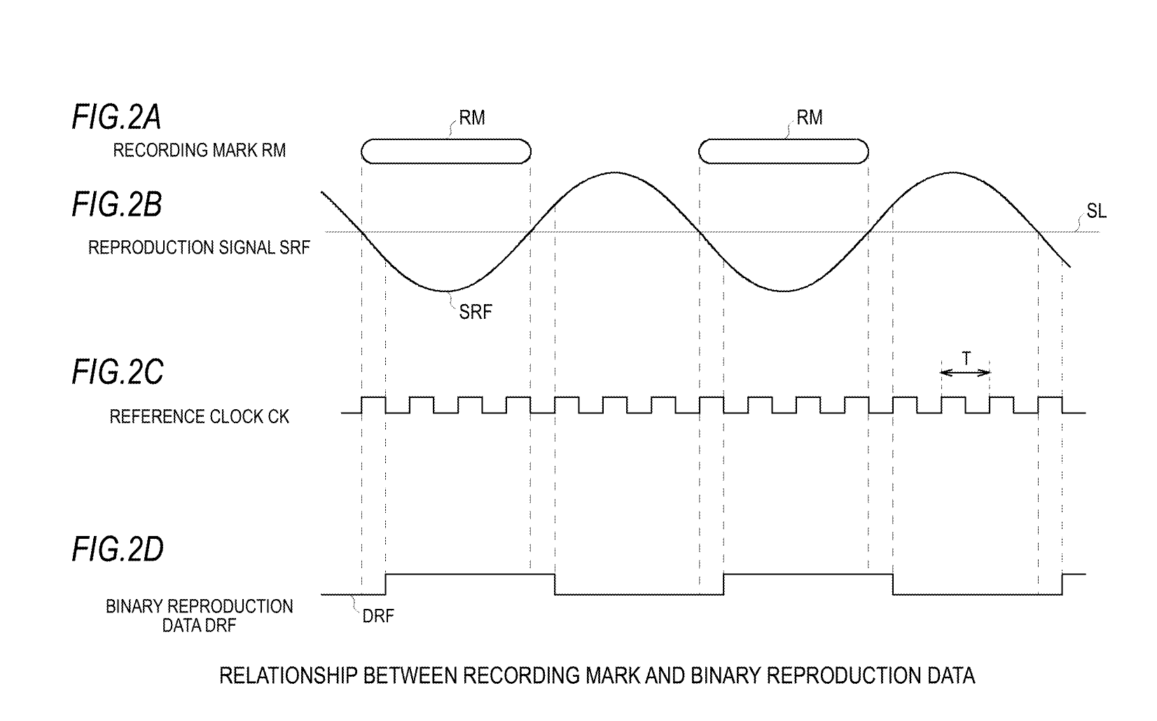

That is, when a light beam is illuminated to a signal recording surface, an optical disc apparatus 1 receives a returning light beam reflected from the signal recording surface. As shown in FIG. 2A, when the recording mark RM is formed on the signal recording surface, the received amount of returning light beams is decreased. As a result, the optical disc apparatus 1 generates a reproduction signal SRF whose signal level increases or decreases according to the existence of the recording mark RM, as shown in FIG. 2B.

In addition, the optical disc apparatus 1 generates binary reproduction data DRF indicating whether or not the recording mark RM exists by binarizing the reproduction signal SRF, for example, according to falling of a reference clock CK, as shown in FIG. 2C.

In addition, by binarization processing, timing of a period of ‘High’ signal level and a period of ‘Low’ signal level in the binary reproduction data DRF is shifted from timing of a ‘High’ period, in which a signal level of the reproduction signal SRF becomes equal to or larger than a reference level SL, and a ‘Low’ period, in which the signal level becomes equal to or smaller than the reference level SL. However, in the binary reproduction data DRF and the reproduction signal SRF, the period of ‘High’ and the period of ‘Low’ correspond to each other and the distances are equal. In addition, the reference level SL in the reproduction signal SRF is determined such that the period of ‘High’ and the period of ‘Low’ in the reproduction signal SRF become almost the same.

Here, in the optical disc 100 based on a BD (Blu-ray disc, registered trademark) method, a DVD (digital versatile disc) method, or a CD (compact disc) method, the mark length of the recording mark RM is determined such that a distance (hereinafter, referred to as a data edge distance) between a rising edge and a falling edge becomes a predetermined edge length by the specification for every method. In addition, the timing at which the binary reproduction data DRF changes from a ‘Low’ level to a ‘High’ level is called a rising edge, and the timing at which the binary reproduction data DRF changes from a ‘High’ level to a ‘Low’ level is called a falling edge.

In addition, hereinbelow, the optical discs 100 based on the BD method, the DVD method, and the CD method are called BD media 100b, DVD media 100d, and CD media 100c, respectively, for the sake of convenience. Moreover, signal recording surfaces that the optical discs 100 have are called a BD recording surface, a DVD recording surface, and a CD recording surface, respectively.

Here, assuming that the reciprocal of a frequency of the reference clock CK in each method is T, edge lengths in the respective optical discs 100 are different. Values of edge length and T (at the time of a normal speed) in each optical disc 100 are shown below.

Edge length of the BD media 100b

2T, 3T, 4T, 5T, 6T, 7T, 8T, and 9T

T=1/66 [MHz]

Edge length of the DVD media 100d

3T, 4T, 5T, 6T, 7T, 8T, 9T, 10T, 11T, and 14T

T=1/26.15625 [MHz]

Edge length of the CD media 100c

3T, 4T, 5T, 6T, 7T, 8T, 9T, 10T, and 11T

T=1/4.3218 [MHz]

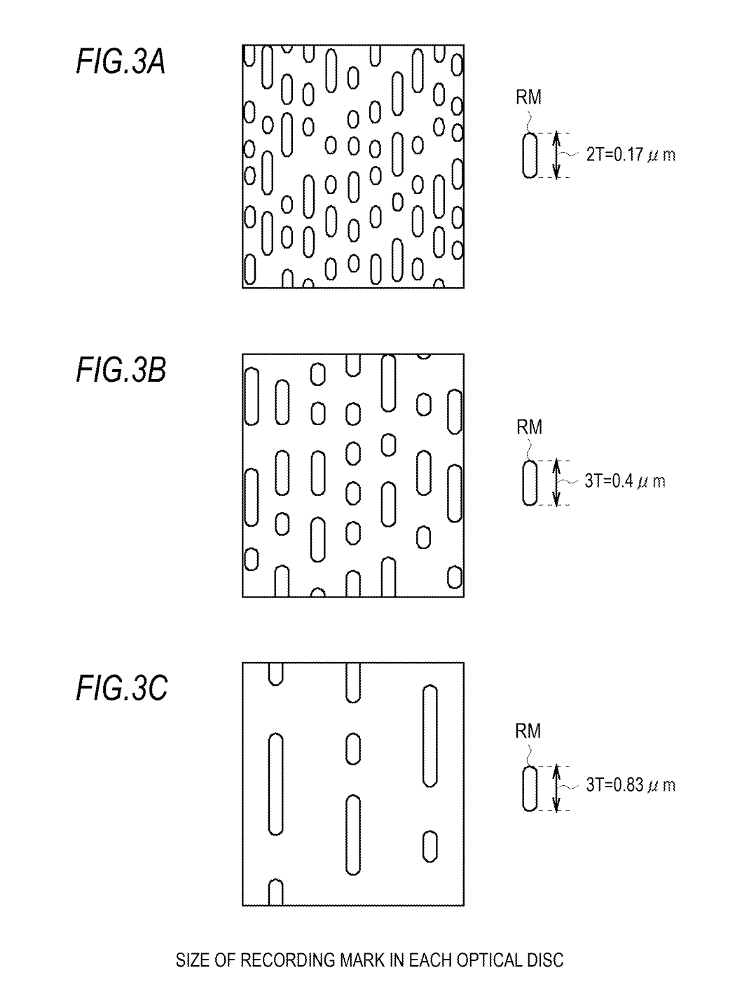

Appearances of the recording marks RM formed on signal recording surfaces of the BD media 100b, the DVD media load, and the CD media 100c are shown in FIGS. 3A, 3B, and 3C, respectively. As can be seen from the drawings, the sizes of the recording marks RM on the BD recording surface, the DVD recording surface, and the CD recording surface are different.

For example, when compared with the mark length of the recording mark RM having a minimum length, a 2T mark in the BD media 100b is about 0.17 [μm], a 3T mark in the DVD media 100d is about 0.4 [μm], and a 3T mark in the CD media 100c is about 0.83 [μm], which are different from each other.

That is, in the optical disc 100, since the size (type of the edge length and the edge length per 1T) of the recording mark RM varies according to the type, the frequency of the reproduction signal SRF is made to change. Accordingly, the optical disc 100 changes the frequency of the binary reproduction data DRF generated by binarizing the reproduction signal SRF according to the type.

Therefore, in the embodiments of the present invention, an objective lens 7 is moved while rotating the optical disc 100 and a light beam is illuminated to the optical disc 100 (hereinafter, these series of operations are referred to as a search operation), and the binary reproduction data DRF is generated from the returning light beam. Furthermore, in the embodiments of the present invention, the type of the optical disc 100 (hereinafter, referred to as an unknown disc 100x) whose type is unknown is determined on the basis of the frequency of the binary reproduction data DRF.

### (2) First Embodiment

### (2-1) Configuration of an Optical Disc Apparatus

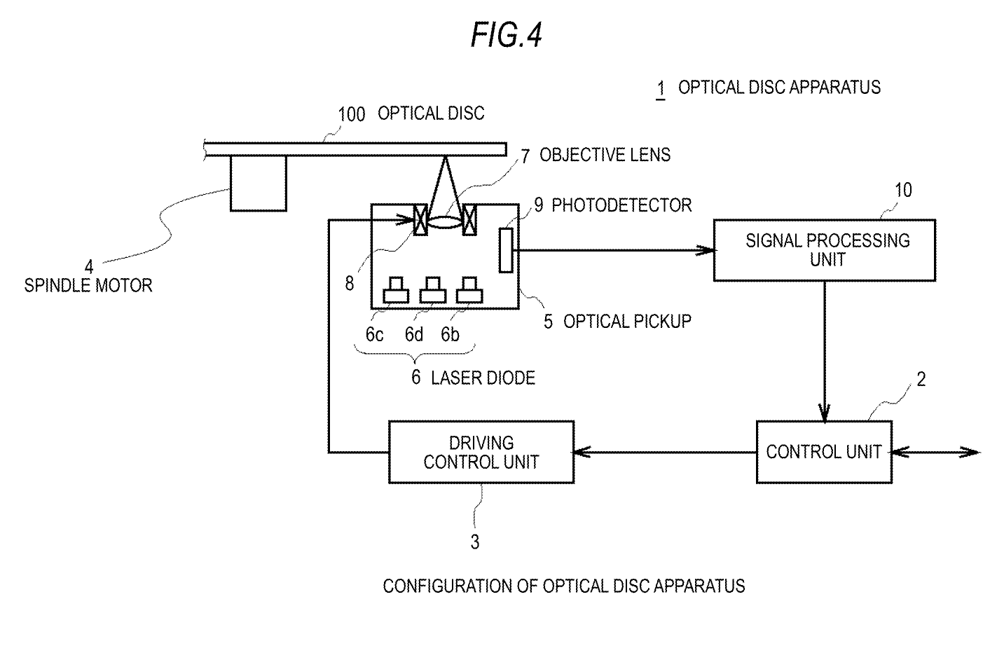

In FIG. 4, the optical disc apparatus 1 records information on the optical disc 100 as an optical recording medium or reproduces the information recorded on the optical disc 100 on the basis of an instruction from an external device (not shown).

In addition, the optical disc apparatus 1 can support all of the optical discs 100 based on the BD media 100b, the DVD media 100d, and the CD media 100c.

In addition, the CD media 100c, the DVD media 100d, and the BD media 100b are common in a point of disc shape with an external diameter of about 120 [mm] and a thickness of about 1.2 [mm]. However, the wavelength of a light beam used in recording and reproducing information, the numerical aperture of an objective lens for condensing light beams, and a distance (what is called a thickness of a cover layer) from a surface to which a light beam is illuminated to a recording layer on which information is recorded are different.

Specifically, in the CD method, the DVD method, and the BD method, the wavelengths of a light beam are set to about 780 [nm], about 660 [nm], and about 405 [nm], numerical apertures of the objective lens are set to about 0.45, about 0.6, and about 0.85, and the thicknesses of the cover layer are set to about 1.2 [mm], about 0.6 [mm], and about 0.1 [mm], respectively.

The optical disc apparatus 1 makes an overall control by a control unit 2. The control unit 2 is configured to include a CPU (central processing unit; not shown) as a main portion. In addition, the control unit 2 executes various kinds of processing, such as determination focus control start processing, by reading various programs, such as a basic program, a media type determination program, and a focus control start program, from a ROM (read only memory; not shown) and loading the read program to a RAM (random access memory; not shown).

The optical disc apparatus 1 reads information recorded on the optical disc 100 when a reproduction instruction is received from an external device (not shown) in a state where the optical disc 100 is loaded, for example.

In practice, a driving control unit 3 rotates the optical disc 100 and illuminates a light beam from an optical pickup 5 to the optical disc 100 by controlling driving of a spindle motor 4 on the basis of an instruction of the control unit 2.

The optical pickup 5 is of a so-called three-wavelength support type and has a CD laser diode 6c which emits a light beam for a CD with a wavelength of about 780 [nm], a DVD laser diode 6d which emits a light beam Ld for a DVD with a wavelength of about 660 [nm], and a BD laser diode 6b which emits a light beam for a BD with a wavelength of about 405 [nm] (hereinafter, collectively referred to as a laser diode 6).

The optical pickup 5 emits a light beam from the laser diode 6 according to the type (that is, one of the CD media 100c, the DVD media load, and the BD media 100b) of the optical disc 100. For example, when the optical disc 100 is the BD media 100b, the optical pickup 5 emits a BD light beam Lb from the BD laser diode 6b. Then, the optical pickup 5 condenses the light beam by the objective lens 7 through an optical component (not shown).

The objective lens 7 is driven by an actuator 8 in a direction approaching or becoming distant from the optical disc 100 along an optical axis of a light beam, that is, in a focus direction. This is to make the objective lens 7 follow the optical disc 100 when so-called surface wobbling and the like occur in the rotating optical disc 100.

In addition, the objective lens 7 is formed by combination of a plurality of optical components (not shown) and acts as a wavelength selective multifocal lens which forms focal points for laser beams with respective wavelengths. Moreover, the objective lens 7 may have a plurality of condensing points by light (hereinafter, referred to as unused light) U which becomes unnecessary due to aperture limitation or change of an optical path by diffraction particularly in a wavelength with a low aperture for wavelength selection.

In practice, while the objective lens 7 can condense the CD light beam with a numerical aperture of about 0.45, condense the DVD light beam Ld with a numerical aperture of about 0.6, and condense the BD light beam with a numerical aperture of about 0.85, the objective lens 7 can condense a light beam with different numerical apertures at the same time.

When a returning light beam generated by reflection of a light beam from the optical disc 100 is incident on the objective lens 7, the optical pickup 5 makes the incident light beam illuminated to a photodetector 9 through an optical component (not shown).

The photodetector 9 has a plurality of detection regions on a surface to which the returning light beam is illuminated, and generates a plurality of light receiving signals by performing photoelectric conversion for every detection region and supplies the light receiving signals to the signal processing unit 10.

The signal processing unit 10 generates a pull-in signal SPI and the reproduction signal SRF indicating the light amount of returning light beams, a focus error signal SFE indicating the amount of deviation between a focal point of a light beam and a signal recording surface of the optical disc 100, a tracking error signal indicating the amount of deviation between a focal point of a light beam and the track center formed on the signal recording surface, and the like by performing predetermined calculation processing on the basis of the light receiving signals and supplies them to the control unit 2.

The control unit 2 supplies a focus driving signal SDF, which brings the focus error signal SFE close to a value ‘0’, to the driving control unit 3 on the basis of the focus error signal SFE. The driving control unit 3 generates a focus driving current on the basis of the focus driving signal SDF and supplies the focus driving current to the actuator 8, thereby moving the objective lens 7 in the focus direction so that the focal point of a light beam is formed on the signal recording surface of the optical disc 100.

That is, the driving control unit 3 makes the focal point of a light beam follow the signal recording surface of the optical disc 100 by performing feedback control of the objective lens 7, through the actuator 8, in the focus direction becoming distant from or approaching to the optical disc 100.

Similarly, the driving control unit 3 makes the focal point of a light beam follow the track center of the optical disc 100 by performing feedback control of the objective lens 7, through the actuator 8, in the tracking direction which is a radial direction of the optical disc 100.

In addition, the signal processing unit 10 generates the binary reproduction data DRF, which indicates whether or not the recording mark RM exists, by binarizing the reproduction signal SRF whose signal level changes according to the recording mark RM recorded on the optical disc 100. In addition, the signal processing unit 10 generates reproduction information by performing predetermined demodulation processing, decoding processing, or the like on the binary reproduction data DRF and transmits the reproduction information to an external device (not shown) through the control unit 2.

In addition, the optical disc apparatus 1 records information on the optical disc 100 when a recording instruction from an external device (not shown), data to be recorded, and the like are received in a state where the optical disc 100 is loaded, for example.

Also in this case, the driving control unit 3 makes a focal point of a light beam follow the signal recording surface of the optical disc 100 by performing feedback control of the objective lens 7 through the actuator 8, similar to the case of reproducing information from the optical disc 100.

Thus, the optical disc apparatus 1 makes a focal point of a light beam follow the signal recording surface of the optical disc 100 by performing a so-called focus control in which a light beam is illuminated to the optical disc 100 and a feedback control of the objective lens 7 is performed in the focus direction on the basis of a detection result of the returning light beam.

### (2-2) Determination of Media Type and Start of Focus Control

Meanwhile, as described above, the wavelength of a light beam to be illuminated at the time of recording and reproduction and the thickness of a cover layer change with the type of the optical disc 100.

For this reason, according to the type of the optical disc 100, the optical disc apparatus 1 needs to change the wavelength of a light beam (that is, needs to determine from which of the CD laser diode 6c, the DVD laser diode 6d, and the BD laser diode 6b a light beam is to be emitted), a focusing position of a light beam in the focus direction (that is, the position of the objective lens 7 in the focus direction), and the number of rotations of the optical disc 100.

Therefore, when the optical disc 100 (hereinafter, referred to as an unknown disc 100x) whose type is unknown is loaded in the optical disc apparatus 1, the optical disc apparatus 1 determines the type of the unknown disc 100x.

In the optical disc apparatus 1 according to the first embodiment, in order to determine the type of the optical disc 100 on the basis of the frequency of the binary reproduction data DRF as described above, a light beam is illuminated while moving the objective lens 7 in a state where the optical disc 100 is rotated.

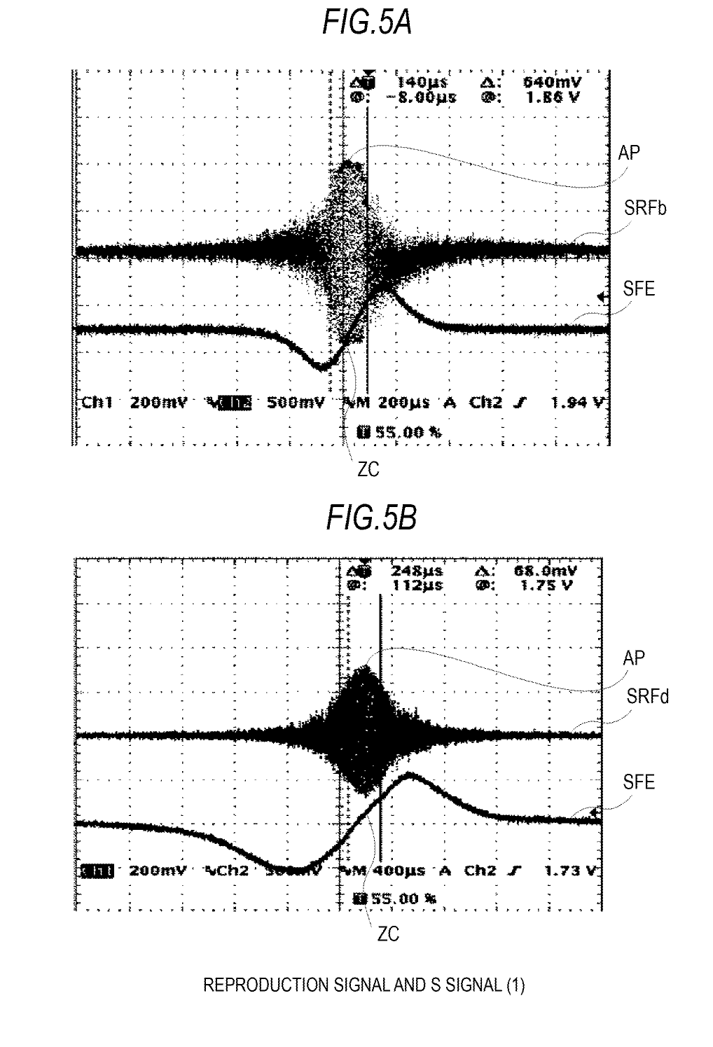

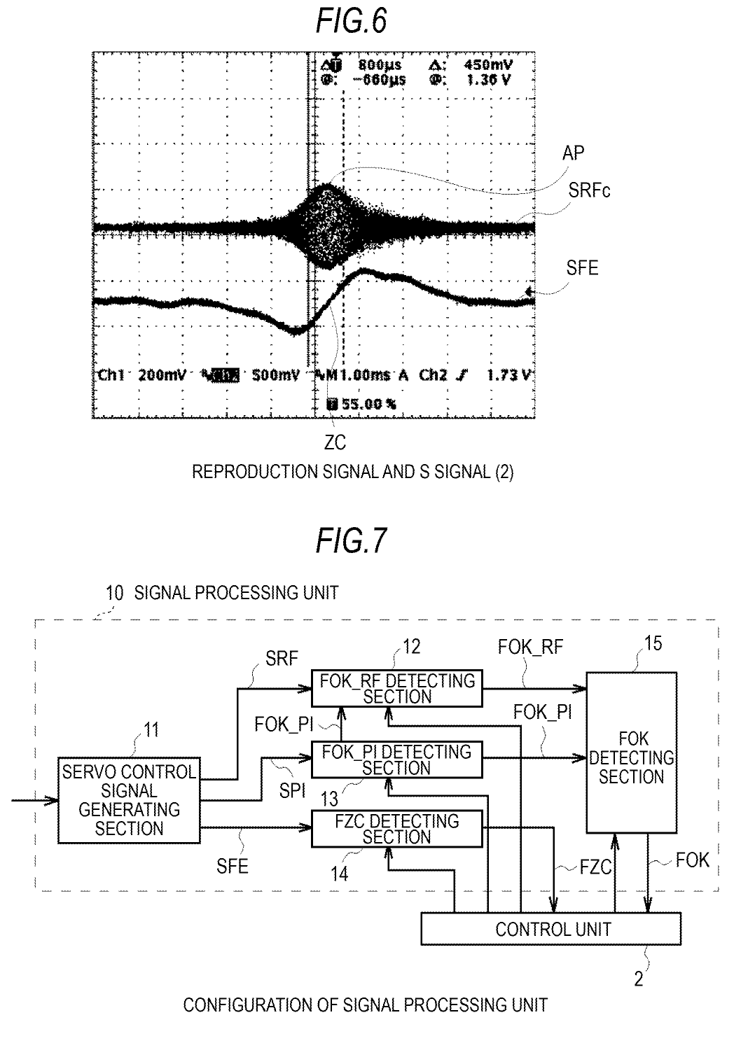

In this case, as shown in FIGS. 5A, 5B, and 6, the optical disc apparatus 1 generates the reproduction signal SRF and the focus error signal SFE on the basis of the light receiving amount of returning light beams. In addition, FIG. 5A shows a reproduction signal SRFb and the focus error signal SFE generated when the BD media 100b is rotated with the number of rotations (hereinafter, referred to as a BD rotation number) corresponding to the specification of the BD method and a search operation is performed by using a BD light beam.

In addition, FIG. 5B shows a reproduction signal SRFd and the focus error signal SFE generated when the DVD media 100d is rotated with the number of rotations (hereinafter, referred to as a DVD rotation number) corresponding to the specification of the DVD method and a search operation is performed by using a DVD light beam Ld. In addition, FIG. 6 shows a reproduction signal SRFc and the focus error signal SFE generated when the CD media 100c is rotated with the number of rotations (hereinafter, referred to as a CD rotation number) corresponding to the specification of the CD method and a search operation is performed by using a CD light beam Lc.

Here, attention is paid to how the existence of the recording mark RM can be determined from the reproduction signal SRF (SRFb, SRFd, and SRFc) obtained as a result of a search operation.

First, a region (hereinafter, referred to as a user region) where data is stored in response to the user's request in the optical disc 100 is shown below as a radius. In addition, also in an inner region than the user region, data and the like stored, for example, at the time of shipment are recorded.

BD media 100b: 24-58 [mm]

DVD media 100d: 24-58 [mm]

CD media 100c: 25-58 [mm]

In addition, the number of rotations of the optical disc 100 changes with the position of the optical disc 100 in the radial direction. Hereinbelow, the number of rotations of the optical disc 100 at radii 24 [mm] and 58 [mm] at the normal speed in each method is shown.

BD media 100b (24 [mm]): 1957.6 [rpm]

BD media 100b (58 [mm]): 810.0 [rpm]

DVD media 100d (24 [mm]): 1388.6 [rpm]

DVD media 100d (58 [mm]): 574.6 [rpm]

CD media 100c (24 [mm]): 954.9 [rpm]

CD media 100c (58 [mm]): 395.1 [rpm]

Here, a maximum value of the reproduction signal SRF becomes highest when light beams are focused on a signal recording surface in a search operation. Assuming that a signal level of the highest maximum value AP was 100 [%] and a period for which the maximum value of the reproduction signal SRF is 80 [%] or more is a focal depth period for which a signal recording surface exists within the focal depth of a light beam, the focal depth period in each optical disc 100 was as follows. In addition, 1×, 2×, and 4× indicate normal speed, double speed, quad speed specified for the type of each optical disc 100, respectively.

BD media 100b (1×): 148 [μsec]

DVD media 100d (2×): 248 [μsec]

CD media 100c (4×): 800 [μsec]

As shown in FIGS. 5A, 5B, and 6, a zero cross point ZC as timing (that is, a focus servo is switched from OFF to ON) at which a focus control starts becomes almost the same timing as the highest maximum value AP of the reproduction signal SRF and is located at the approximate center of the focal depth period.

In other words, in the optical disc apparatus 1, if the type of the optical disc 100 can be determined in a time (hereinafter, referred to as a focal depth half period) of the half of the focal depth period which is from the start of the focal depth period to the highest maximum value AP, it becomes possible to check the type of the optical disc 100 and then start a focus control in the state.

For example, in the BD media 100b, in the case of a normal speed, the frequency of the reference clock CK is 66.0 [MHz], a one channel bit interval indicating the time per 1T is 15.15 [nsec], and a one sink frame interval indicating the time per one sink frame is 29.27 [μsec]. Accordingly, when the BD media 100b is rotated with the BD rotation number of normal speed, information indicating that the focal depth period is 4.8 sink frames and the focal depth half period is 2.4 sink frames is included.

Moreover, in the DVD media 100d, in the case of a normal speed, the frequency of the reference clock CK is 26.15625 [MHz], the one channel bit interval is 38.23 [nsec], and the one sink frame interval is 56.88 [μsec]. Accordingly, when the DVD media 100d is rotated with the DVD rotation number of double speed, information indicating that the focal depth period is 8.7 sink frames and the focal depth half period is 4.3 sink frames is included.

Moreover, in the CD media 100c, in the case of a normal speed, the frequency of the reference clock CK is 4.3218 [MHz], the one channel bit interval is 231.4 [nsec], and the one sink frame interval is 136.05 [μsec]. Accordingly, when the CD media 100c is rotated with the CD rotation number of quad speed, information indicating that the focal depth period is 23.5 sink frames and the focal depth half period is 11.7 sink frames is included.

Here, from definition of each specification of the BD media 100b, the DVD media 100d, and the CD media 100c, data of all lengths (that is, 2T to 9T in the BD media 100b, 3T to 11T and 14T in the DVD media 100d, and 3T to 11T in the CD media 100c) is included in the one sink frame.

Therefore, it can be seen that determining the type of the optical disc 100 on the basis of the frequency of the binary reproduction data DRF, which is generated from the reproduction signal SRF during the focal depth half period, is theoretically possible.

Accordingly, in the optical disc apparatus 1, the optical disc 100 is rotated with the number of rotations according to a light beam illuminated. Then, when the unknown disc 100x is the optical disc 100 of the type corresponding to the light beam illuminated, determination focus control start processing for starting the focus control with respect to the optical disc 100 in the state is executed.

In addition, as described above, since the thicknesses of the cover layers of the BD media 100b, the DVD media 100d, and the CD media 100c are different, positions of signal recording surfaces (BD recording surface, DVD recording surface, and CD recording surface) are also different. In addition, unlike known optical disc apparatuses, it is not necessary to detect the surface position of the optical disc 100.

For this reason, the optical disc apparatus 1 determines first whether or not the unknown disc 100x is the BD media 100b by bringing the objective lens 7 close to the unknown disc 100x from a most distant position at which the objective lens 7 is most distant from the unknown disc 100x. When it is determined that the unknown disc 100x is not the BD media 100b, the optical disc apparatus 1 determines whether or not the unknown disc 100x is the DVD media 100d by bringing the objective lens 7 closer to the unknown disc 100x in the state. Then, the optical disc apparatus 1 determines whether or not the unknown disc 100x is the CD media 100c by bringing the objective lens 7 closer to the unknown disc 100x in the state.

### (2-2-1) BD Media Determination

As the determination focus control start processing, the optical disc apparatus 1 first executes a search operation using the BD light beam Lb in order to determine whether or not the unknown disc 100x is the BD media 100b.

Specifically, the control unit 2 (FIG. 4) of the optical disc apparatus 1 rotates the unknown disc 100x with the BD rotation number corresponding to the position of the objective lens 7 by applying a voltage to the spindle motor 4 through the driving control unit 3. In addition, the control unit 2 illuminates the BD light beam Lb to the unknown disc 100x by emitting the BD light beam Lb from the BD laser diode 6b while moving the objective lens 7 in the focus direction at a fixed moving speed by controlling a voltage applied to the actuator 8.

As a result, the photodetector 9 receives a returning BD light beam Lbr generated by reflection of the BD light beam Lb from the unknown disc 100x. The photodetector 9 generates a light receiving signal corresponding to the light receiving amount of the returning BD light beam Lbr and supplies the light receiving signal to the signal processing unit 10.

As shown in FIG. 7, a servo control signal generating section 11 of the signal processing unit 10 generates the pull-in signal SPI, the reproduction signal SRFb, and the focus error signal SFE on the basis of the light receiving signal supplied from the optical pickup 5 and supplies the signals to an FOK_PI detecting section 13, an FOK_RF detecting section 12, and an FZC detecting section 14, respectively.

The FOK_PI detecting section 13 monitors a signal level of the pull-in signal SPI, generates a measurement timing signal FOK_PI indicating that the pull-in signal SPI is equal to or larger than a predetermined measurement threshold value, and supplies the measurement timing signal FOK_PI to the FOK_RF detecting section 12 and an FOK detecting section 15. In addition, the measurement threshold value is set to a value allowing the sufficient light amount, with which the reproduction signal SRFb in the returning BD light beam Lbr can be binarized, to be obtained and does not necessarily need to be set to correspond to the focal depth period described above. For example, the measurement threshold value is set to a value (that is, 40 to 50 [%] of a maximum value of the pull-in signal SPI) corresponding to 40 to 50 [%] of the highest maximum value AP in the reproduction signal SRFb.

The FOK_RF detecting section 12 generates binary reproduction data DRFb from the reproduction signal SRFb and starts disc determination processing (will be described in detail later) on the basis of the frequency of the binary reproduction data DRFb. Specifically, the FOK_RF detecting section 12 starts detection of the BD recording surface from the unknown disc 100x when the FOK_RF detecting section 12 recognizes that the pull-in signal SPI is equal to or larger than the predetermined measurement threshold value since the measurement timing signal FOK_PI is at a ‘High’ level.

Then, the FOK_RF detecting section 12 generates a disc determination signal FOK_RF indicating whether or not the BD recording surface has been detected from the unknown disc 100x and supplies the disc determination signal FOK_RF to the FOK detecting section 15.

The FOK detecting section 15 determines whether or not the measurement timing signal FOK_PI and the pull-in signal SPI are equal to or larger than a predetermined measurement threshold value when the FOK detecting section 15 recognizes that the BD recording surface has been detected from the unknown disc 100x since the disc determination signal FOK_RF is at a ‘High’ level.

At this time, if the measurement timing signal FOK_PI and the pull-in signal SPI are equal to or larger than the predetermined measurement threshold value, the FOK detecting section 15 generates a recording surface check signal FOK indicating whether or not the BD recording surface is detected on the basis of the returning BD light beam Lbr with the sufficient light amount and supplies the recording surface check signal FOK to the FZC detecting section 14 through the control unit 2.

Here, the BD recording surface is detected and the measurement timing signal FOK_PI and the pull-in signal SPI are equal to or larger than the predetermined measurement threshold value means, in other words, that the focal point of the BD light beam Lb is located near the BD recording surface. Therefore, the optical disc apparatus 1 is configured to detect the timing at which the focal point of the BD light beam Lb is formed on the BD recording surface and to start a focus control in the state.

The FZC detecting section 14 generates a zero cross signal FZC indicating that the zero cross point ZC has been detected from the focus error signal SFE when the FZC detecting section 14 recognizes that the BD recording surface has been detected on the basis of the returning light beam Lbr with the sufficient light amount since the recording surface check signal FOK is at a ‘High’ level, and supplies the zero cross signal FZC to the control unit 2.

When the control unit 2 recognizes that the zero cross point ZC has been detected from the focus error signal SFE since the zero cross signal FZC is at a ‘High’ level, the control unit 2 switches the focus control from ‘OFF’ to ‘ON’ and starts the focus control.

On the other hand, the control unit 2 of the optical disc apparatus 1 determines that the unknown disc 100x is not the BD media 100b when the recording surface check signal FOK does not rise to a ‘High’ level in spite of having moved the objective lens 7 to a predetermined DVD switching position. Subsequently, the control unit 2 executes a search operation using a DVD light beam Ld in order to determine whether or not the unknown disc 100x is the DVD media 100b.

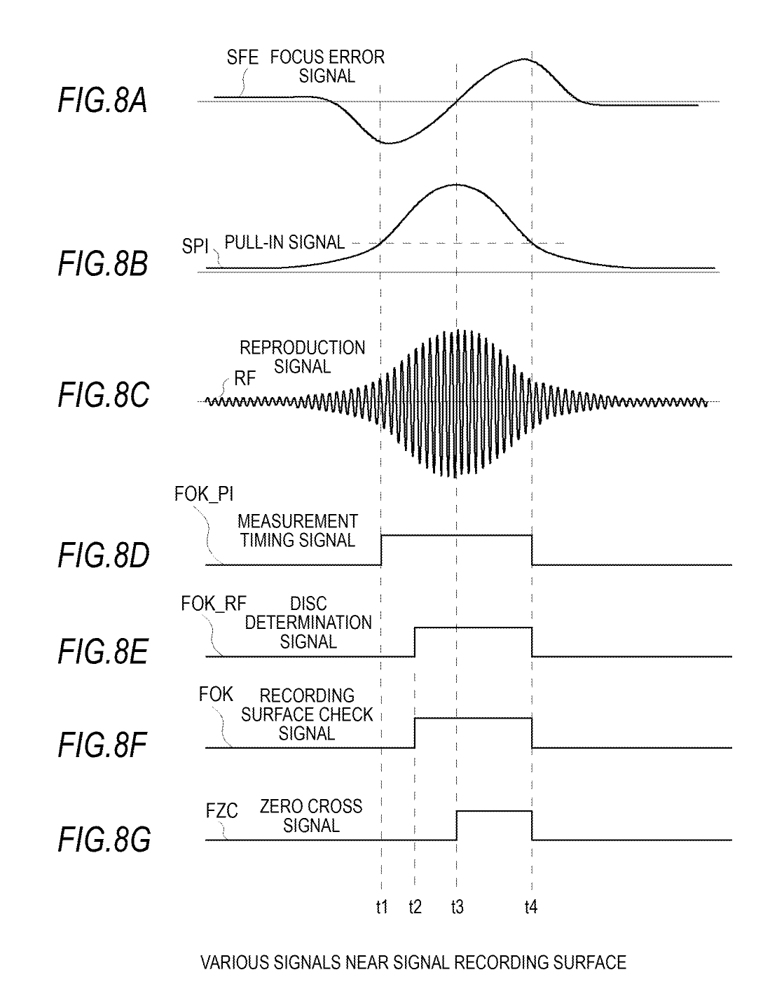

For example, when the pull-in signal SPI becomes equal to or larger than the predetermined measurement threshold value at time t1 as shown in FIG. 8B, the FOK_PI detecting section 14 makes the measurement timing signal FOK_PI (FIG. 8D) rise from a ‘Low’ level to a ‘High’ level. At this time, the FOK_RF detecting section 12 starts disc determination processing on the basis of the reproduction signal SRFb (FIG. 8C).

At time t2, when a BD recording surface is detected, the FOK_RF detecting section 12 makes the disc determination signal FOK_RF (FIG. 8E) rise from a ‘Low’ level to a ‘High’ level.

At this time, the FOK detecting section 15 makes the recording surface check signal FOK (FIG. 8F) rise from a ‘Low’ level to a ‘High’ level when it is checked that both the measurement timing signal FOK_PI and the disc determination signal FOK_RF are at a ‘High’ level. At this time, the FZC detecting section 15 starts monitoring of the focus error signal SFE (FIG. 8A). In addition, the control unit 2 starts monitoring of the zero cross signal FZC (FIG. 8G).

At time t3, when the zero cross point ZC is detected from the focus error signal SFE, the FZC detecting section 14 makes the zero cross signal FZC rise from a ‘Low’ level to a ‘High’ level. At this time, the control unit 2 switches a focus control from ‘OFF’ to ‘ON’ to start the focus control.

Then, when the measurement timing signal FOK_PI falls to a ‘Low’ level at time t4 since the signal level of the pull-in signal SPI has become less than the measurement threshold value, the signal processing unit 10 makes the disc determination signal FOK_RF, the recording surface check signal FOK, and the zero cross signal FZC fall to a ‘Low’ level.

Thus, the optical disc apparatus 1 detects the BD recording surface from the unknown disc 100x by executing a search operation in a state where the unknown disc 100x is rotated with the BD rotation number. In addition, the optical disc apparatus 1 can determine that the unknown disc 100x is the BD media 100b by detecting the BD recording surface and start a focus control with respect to the BD recording surface in the state.

### (2-2-2) DVD Media Determination

The control unit 2 of the optical disc apparatus 1 changes the number of rotations of the unknown disc 100x to the DVD rotation number corresponding to the position of the objective lens 7 by changing a voltage applied to the spindle motor 4 while moving the objective lens 7 in the focus direction at a fixed moving speed by controlling a voltage applied to the actuator 8 through the driving control unit 3. In addition, the control unit 2 illuminates the DVD light beam Ld to the unknown disc 100x by emitting the DVD light beam Ld from the DVD laser diode 6d.

As a result, the photodetector 9 receives a returning DVD light beam Ldr generated by reflection of the DVD light beam Ld from the unknown disc 100x. The photodetector 9 generates a light receiving signal corresponding to the light receiving amount of the returning DVD light beam Ldr and supplies the light receiving signal to the signal processing unit 10.

The servo control signal generating section 11 (FIG. 7) of the signal processing unit 10 generates the pull-in signal SPI, the reproduction signal SRFd, and the focus error signal SFE on the basis of the light receiving signal supplied from the optical pickup 5 and supplies the signals to the FOK_PI detecting section 13, the FOK_RF detecting section 12, and the FZC detecting section 14, respectively.

In addition, similar to the case of the BD media 100b, when the DVD recording surface has been detected from the unknown disc 100x, the control unit 2 determines that the unknown disc 100x is the DVD media 100d on the basis of the reproduction signal SRFd and starts the focus control.

On the other hand, the control unit 2 determines that the unknown disc 100x is not the DVD media 100d when the recording surface check signal FOK does not rise to a ‘High’ level in spite of having moved the objective lens 7 to a predetermined CD switching position. Then, the control unit 2 executes a search operation using the CD light beam Lc in order to determine whether or not the unknown disc 100x is the CD media 100c.

### (2-2-3) CD Media Determination

The control unit 2 of the optical disc apparatus 1 changes the number of rotations of the unknown disc 100x to the CD rotation number corresponding to the position of the objective lens 7 by changing a voltage applied to the spindle motor 4 while moving the objective lens 7 in the focus direction at a fixed moving speed by controlling a voltage applied to the actuator 8 through the driving control unit 3. In addition, the control unit 2 illuminates the CD light beam Lc to the unknown disc 100x by emitting the CD light beam Lc from the CD laser diode 6c.

As a result, the photodetector 9 receives a returning CD light beam Lcr generated by reflection of the CD light beam Lc from the unknown disc 100x. The photodetector 9 generates a light receiving signal corresponding to the light receiving amount of the returning CD light beam Lcr and supplies the light receiving signal to the signal processing unit 10.

The servo control signal generating section 11 (FIG. 7) of the signal processing unit 10 generates the pull-in signal SPI, the reproduction signal SRFc, and the focus error signal SFE on the basis of the light receiving signal supplied from the optical pickup 5 and supplies the signals to the FOK_PI detecting section 13, the FOK_RF detecting section 12, and the FZC detecting section 14, respectively.

Here, as described above, particularly in a search operation using the CD light beam Lc, many fake patterns Pf generated by reflection of light beams other than the CD light beam Lc from the surface of the unknown disc 100x or the like appear in the focus error signal SFE or the pull-in signal SPI.

Meanwhile, the FOK detecting section 15 makes the recording surface check signal FOK rise to a ‘High’ level only when signal levels of both the measurement timing signal FOK_PI and the disc determination signal FOK_RF are ‘High’. That is, the control unit 2 determines that the unknown disc 100x is the CD media 100c only when the pull-in signal SPI is equal to or larger than the predetermined measurement threshold value and the CD recording surface is detected from the unknown disc 100x by disc determination processing, and starts the focus control.

Here, the FOK_RF detecting section 12 executes disc determination processing on the basis of the frequency of the binary reproduction data DRF as described above. Since the fake pattern Pf is generated when a condensing point of the unused light U is reflected by the surface of the unknown disc 100x or the like, the fake pattern Pf does not increase or decrease the signal level of the reproduction signal SRF according to the recording mark RM and the periodic binary reproduction data DRF is difficult to be generated by the fake pattern Pf. For this reason, the FOK_RF detecting section 12 does not detect the CD recording surface by the disc determination processing on the fake pattern Pf.

Accordingly, the control unit 2 can detect the CD recording surface of the CD media 100c correctly and start the focus control with respect to the CD recording surface.

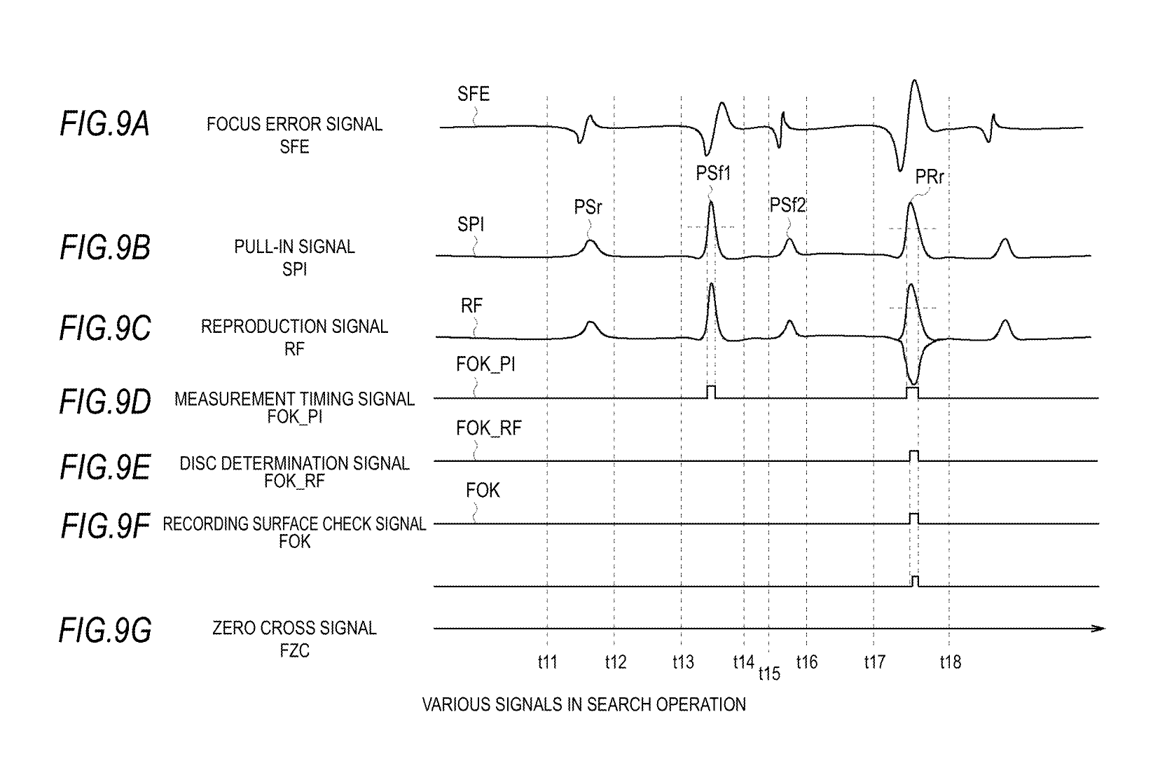

In FIGS. 9A to 9G, a case where the CD light beam Lc is illuminated to the CD media 100c, in which the fake pattern Pf appears most frequently, until the CD recording surface is detected through the objective lens 7 at the most distant location is shown for the sake of convenience. In practice, since light beams are switched, waveforms of various signals are slightly different from those in FIGS. 8A to 8G.

During a period from time t11 to t12, a surface reflection pattern PSr generated by reflection of the CD light beam Lc from the surface of the unknown disc 100x appears in the pull-in signal SPI (FIG. 8B). In the pull-in signal SPI, the signal level in the surface reflection pattern PSr does not become equal to or larger than a measurement threshold value. At this time, the control unit 2 continues the search operation since the recording surface check signal FOK does not rise either.

During a period from time t13 to t14, a surface fake pattern PSf1 generated by reflection of the unused light U, which has a condensing point corresponding to the DVD media 100d, from the surface of the unknown disc 100x appears in the pull-in signal SPI. At this time, since the pull-in signal SPI becomes equal to or larger than the measurement threshold value, the FOK_PI detecting section 13 makes the measurement timing signal FOK_PI rise to a ‘High’ level.

Since the FOK_RF detecting section 12 executes the disc determination processing but a change corresponding to a recording mark does not appear in the reproduction signal SRFc, the FOK_RF detecting section 12 does not detect the CD recording surface on the basis of the reproduction signal SRFc. In addition, when the pull-in signal SPI becomes less than the measurement threshold value, the FOK_PI detecting section 13 makes the measurement timing signal FOK_PI fall to a ‘Low’ level. At this time, the control unit 2 continues the search operation since the recording surface check signal FOK does not rise.

During a period from time t15 to t16, a surface fake pattern PSf2 generated by reflection of the unused light U, which has a condensing point corresponding to the BD media 100b, from the surface of the unknown disc 100x appears in the pull-in signal SPI. In the pull-in signal SPI, the signal level in the surface fake pattern PSf2 does not become equal to or larger than the measurement threshold value. At this time, the control unit 2 continues the search operation since the recording surface check signal FOK does not rise either.

During a period from time t17 to t18, a recording surface reflection pattern PRr generated by reflection of the CD light beam Lc from a CD recording surface appears in the pull-in signal SPI. At this time, since the pull-in signal SPI becomes equal to or larger than the measurement threshold value, the FOK_PI detecting section 13 makes the measurement timing signal FOK_PI rise to a ‘High’ level.

When the FOK_RF detecting section 12 executes the disc determination processing and a change corresponding to the recording mark RM formed on the CD recording surface appear in the reproduction signal SRFc, the FOK_RF detecting section 12 detects the CD recording surface. At this time, the FOK_RF detecting section 12 makes the disc determination signal FOK_RF rise to a ‘High’ level. Accordingly, the FOK detecting section 15 checks that the measurement timing signal FOK_PI is at a ‘High’ level and makes the recording surface check signal FOK rise to a ‘High’ level, allowing the start of focus control.

Then, the control unit 2 starts the focus control when the FZC detecting section 14 detects the zero cross point ZC from the focus error signal SFE. That is, the control unit 2 starts the focus control by switching a focus loop from ‘OFF’ to ‘ON’ and driving the objective lens 7 so that the focus error signal SFE becomes zero.

Thus, in the optical disc apparatus 1, start of the focus control is allowed according to rising of the recording surface check signal FOK so that the focus control can be approximately started only when light beams are almost focused on the signal recording surface.

### (2-3) Disc Determination Processing

Next, disc determination processing executed on the basis of the frequency of the binary reproduction data DRF will be described.

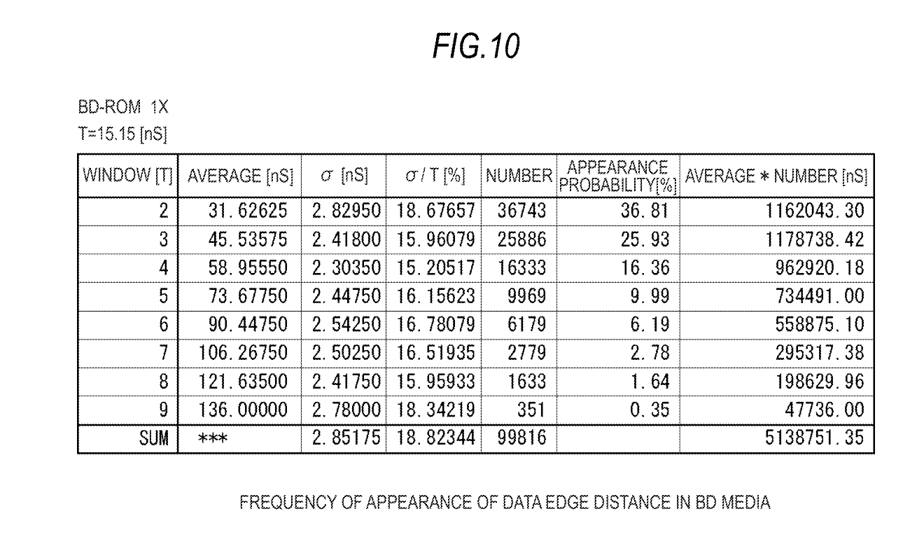

Data edge distances and an appearance probability of each data edge distance which are actually measured from the binary reproduction data DRF using a time interval analyzer in the BD media 100b (BD-ROM, normal speed) are shown in FIG. 10. Moreover, in this measurement, values when measuring data edge distances of about 100,000 samples are shown.

In the drawing, ‘Window’ indicates each edge length (2T, 3T, 4T . . . ), ‘Average’ indicates an average value of data edge distances determined to be each data length, ‘σ’ indicates a variation in data edge distance determined to be each data length, ‘σ/T’ indicates a value obtained by dividing the variation by T, ‘Number’ indicates the number of data edge distances determined to be each data length, ‘appearance probability’ indicates a ratio of the number of data edge distances determined to be each data length to all samples, and ‘Average*Number’ indicates the total time for which data edge distances determined to be each data length have appeared.

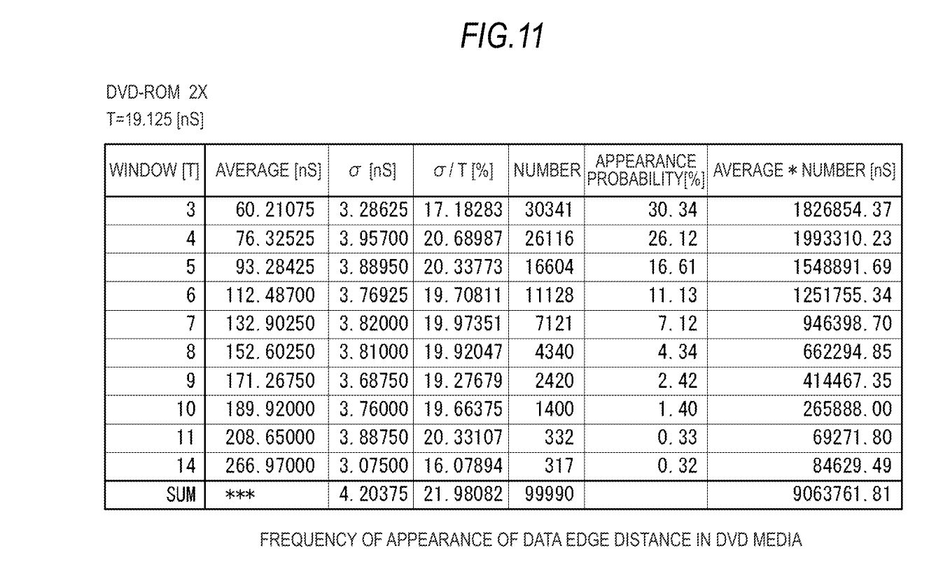

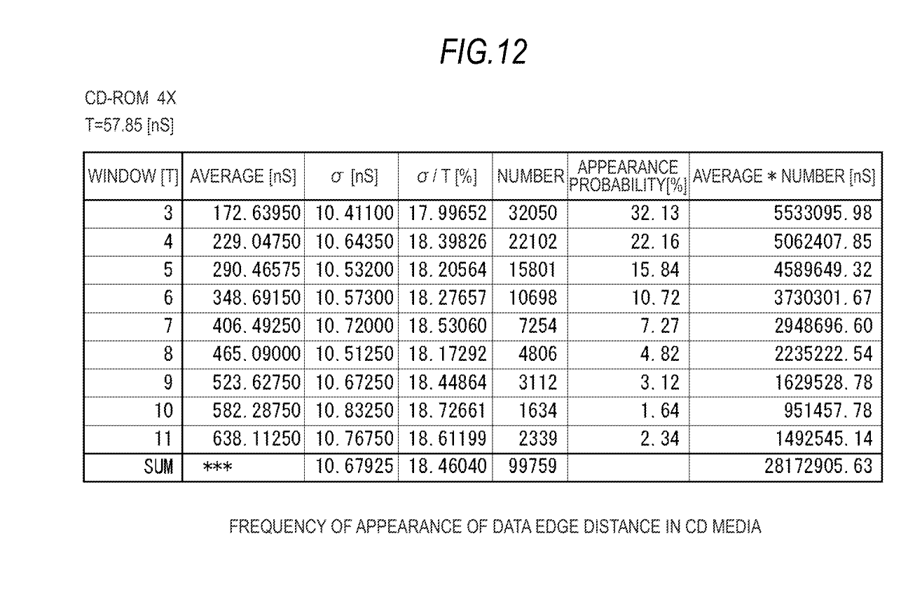

Moreover, in FIGS. 11 and 12, data edge distances and an appearance probability of each data edge distance which are actually measured in the DVD media 100d (DVD-ROM, double speed) and the CD media 100c (CD-ROM, quad speed) are shown. Measurement conditions and items in the drawing are the same as those in FIG. 10.

The drawings show that the shorter the edge length, the higher the appearance probability, and the longer the edge length, the lower the appearance probability in any of the BD media 100b, the DVD media load, and the CD media 100c.

Therefore, in case of determining the type of the unknown disc 100x by counting the appearance number of data edge distance as specific edge length in the binary reproduction data DRF, the determination can be made in a short time by measuring a data edge distance as a short edge length rather than counting data edge distances as long edge lengths.

In addition, the accuracy of determination can be improved by counting the appearance number of data edge distances as a plurality of edge lengths, compared with a case where the appearance number of data edge distance as a single edge length.

Accordingly, in the optical disc apparatus 1, the type of the optical disc 100 is determined by counting data edge distances which are three edge lengths from a short side.

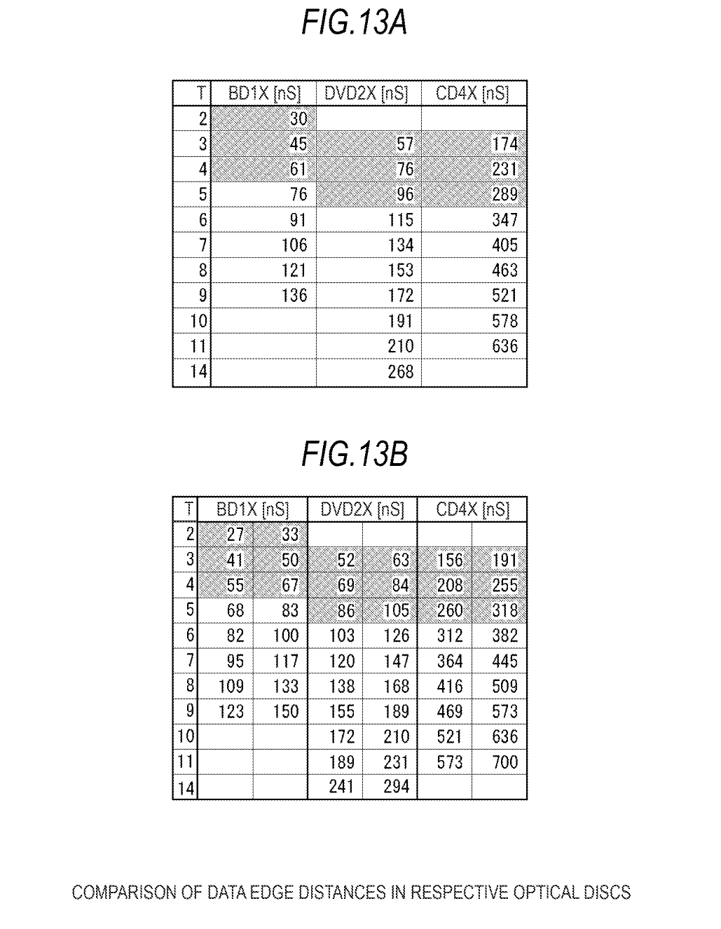

Specifically, as shown by diagonal lines in FIGS. 13A and 13B, the control unit 2 of the optical disc apparatus 1 sets edge lengths of 2T, 3T, and 4T as target edge lengths to be counted for the BD media 100b and sets edge lengths of 3T, 4T, and 5T as target edge lengths for the DVD media 100d and the CD media 100c.

At this time, the optical disc apparatus 1 sets a value, which is larger by 10 [%] than a target edge length N, and a value, which is smaller by 10 [%] than the target edge length N, as a target threshold range for determining whether or not it is the target edge length N.

That is, in case of the BD media 100b, a value obtained by adding 10% of a value (Na: 2T=30 [nsec], Nb: 3T=45 [nsec], Nc: 4T=61 [nsec]) of the target edge length N to the value of the target edge length N and a value obtained by subtracting 10% of the value of the target edge length N from the value of the target edge length N are set as the target threshold range corresponding to the target edge length N. In addition, the target threshold range becomes values (Na: 27 to 33 [nsec] (that is, equal to or larger than 27 [nsec] and equal to or smaller than 33 [nsec]; hereinafter, ‘to’ is used as the same meaning), Nb: 41 to 50 [nsec], Nc: 55 to 67 [nsec]) shown by diagonal lines in FIG. 13B.

Moreover, in case of the DVD media 100d, a value obtained by adding 10% of a value (Na: 3T=57 [nsec], Nb: 4T=76 [nsec], Nc: 5T=96 [nsec]) of the target edge length N to the value of the target edge length N and a value obtained by subtracting 10% of the value of the target edge length N from the value of the target edge length N are set as the target threshold range corresponding to the target edge length N. In addition, the target threshold range becomes values (Na: 52 to 63 [nsec], Nb: 69 to 84 [nsec], Nc: 86 to 105 [nsec]) shown by diagonal lines in FIG. 13B.

Moreover, in case of the CD media 100c, a value obtained by adding 10% of a value (Na: 3T=174 [nsec], Nb: 4T=231 [nsec], Nc: 5T=289 [nsec]) of the target edge length N to the value of the target edge length N and a value obtained by subtracting 10% of the value of the target edge length N from the value of the target edge length N are set as the target threshold range corresponding to the target edge length N. In addition, the target threshold range becomes values (Na: 156 to 191 [nsec], Nb: 208 to 255 [nsec], Nc: 260 to 318 [nsec]) shown by diagonal lines in FIG. 13B.

In addition, the optical disc apparatus 1 measures the appearance number of data edge distances (distance from the rising edge to the falling edge and distance from the falling edge to the rising edge) determined to be in the target threshold range in the binary reproduction data DRF at the time of disc determination processing.

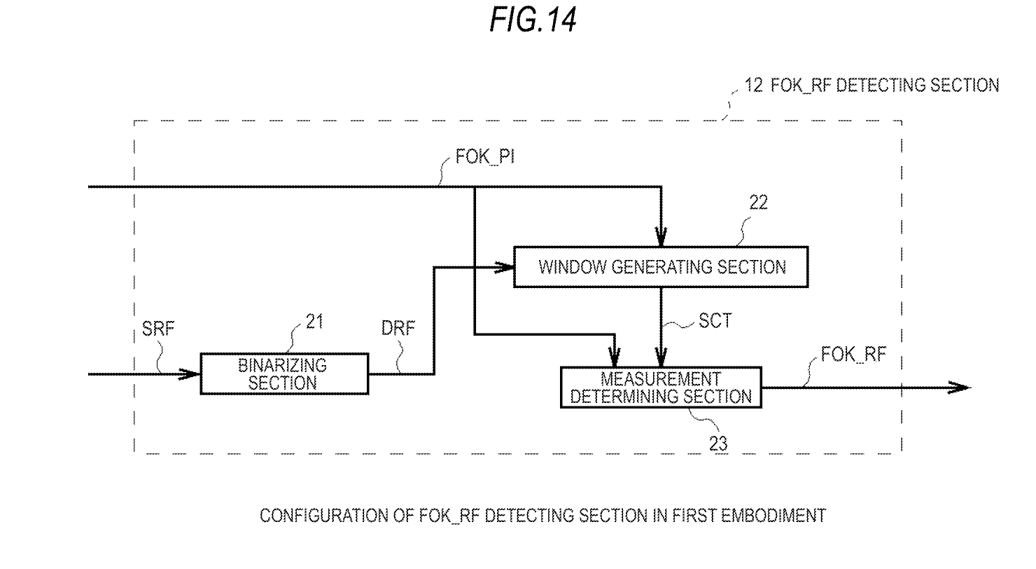

Specifically, as shown in FIG. 14, when the reproduction signal SRF is supplied to the FOK_RF detecting section 12 of the optical disc apparatus 1, the FOK_RF detecting section 12 generates the binary reproduction data DRF by binarizing the reproduction signal SRF with a binarizing section 21 and supplies the binary reproduction data DRF to a window generating section 22.

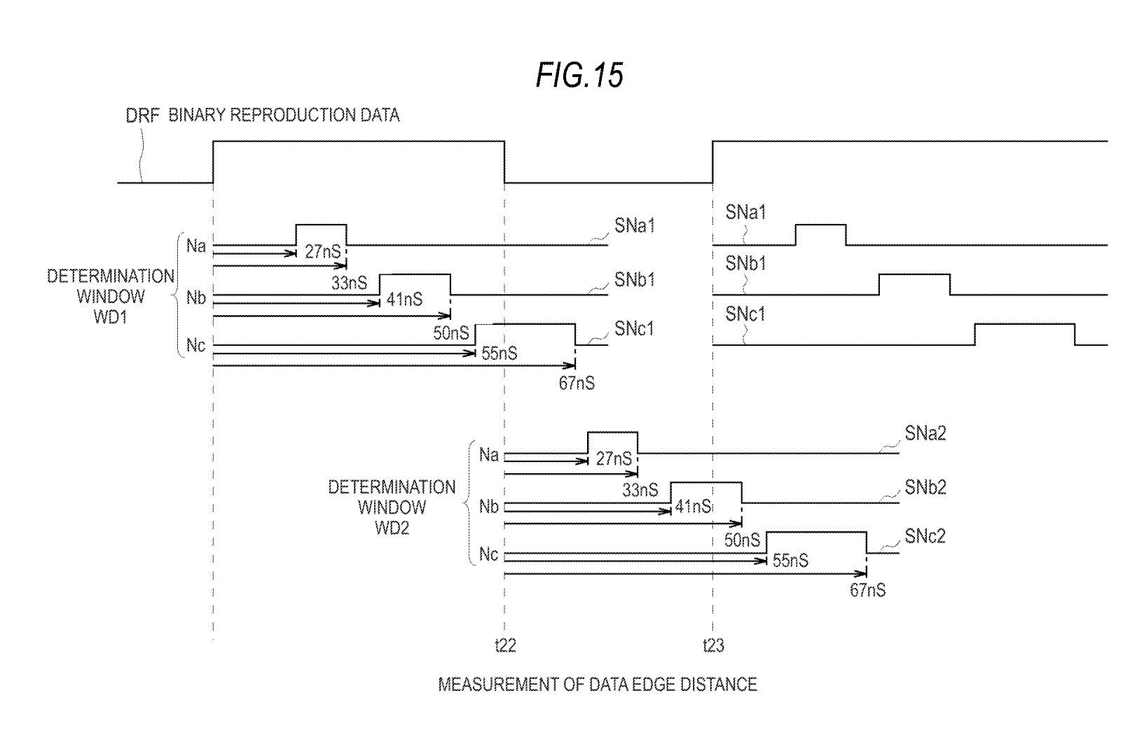

The window generating section 22 starts a determination window WD1, which measures a data edge distance from the rising edge of the binary reproduction data DRF to the falling edge thereof, and a determination window WD2, which measures a data edge distance from the falling edge of the binary reproduction data DRF to the rising edge thereof, as shown in FIG. 15.

When the data edge distance as the target edge length is detected from the binary reproduction data DRF by the determination windows WD1 and WD2, the window generating section 22 generates a count signal SCT and supplies the count signal SCT to a measurement determining section 23.

As shown in FIG. 15, the window generating section 22 generates determination timing signals SNa1 to SNc1 corresponding to the rising edge of the binary reproduction data DRF by the determination window WD1.

For example, the determination window WD1 generates the determination timing signals SNa1 to SNc1 corresponding to the rising edge of the binary reproduction data DRF at time t21 in disc determination processing while the search operation using the BD light beam Lb is being executed. The determination window WD1 counts a time from the rising edge of the binary reproduction data DRF and makes signal levels of the determination timing signals SNa1 to SNc1 rise to ‘High’ levels over target threshold ranges (27 to 33 [nsec], 41 to 50 [nsec], 55 to 67 [nsec]) corresponding to target edge lengths Na to Nc.

When the binary reproduction data DRF falls at time t22, the window generating section 22 determines which signal level of the determination timing signals Sna1 to SNc1 is at a ‘High’ level and starts the determination window WD2.

For example, when the determination timing signal SNc was at a ‘High’ level, the window generating section 22 determines that the data edge distance is the target edge length Nc, supplies the count signal SCT to the measurement determining section 23, and waits a next rising edge is detected.

On the other hand, in the case where all signal levels of the determination timing signals SNa1 to SNc1 were at ‘Low’ levels when the binary reproduction data DRF fell, the window generating section 22 waits until the next rising edge is detected.

The determination window WD2 generates determination timing signals SNa2 to SNc2 from time t23 corresponding to falling of the binary reproduction data DRF at time t23 and determines whether or not the data edge distance from the falling edge to the rising edge is the target edges Na to Nc similar to the determination window WD1.

In addition, the window generating section 22 executes the same processing as the case where the search operation using the BD light beam Lb is executed, at the time of disc determination processing while executing the search operation using the DVD light beam Ld or the CD light beam Lc. That is, the window generating section 22 generates the determination timing signals SNa1 to SNc1, which rise corresponding to the rising edge of the binary reproduction data DRF, and determines whether or not the data edge distance is the target edges Na to Nc corresponding to the DVD media 100d or the CD media 100c.

When the count signal SCT is supplied to the measurement determining section 23, the measurement determining section 23 recognizes that the data edge distance as the target edge length N has been detected and measures the number of data edge distances detected for every target edge length Na to Nc.

Then, the measurement determining section 23 determines that a signal recording surface of a determination target disc, which is to be determined, has been detected from the unknown disc 100x, when the number of data edge distances as the target edge lengths Na to Nc reaches an appearance threshold value (for example, 10).

Thus, the optical disc apparatus 1 recognizes that a signal recording surface corresponding to a determination target disc has been detected from the unknown disc 100x when a data edge distance as the target edge length N corresponding to the determination target disc is measured a number of times equal to or larger than the appearance threshold value from the binary reproduction data SRF, and determines the type of the unknown disc 100x from the detected signal recording surface.

As described above, since the optical disc apparatus 1 can check that the recording mark RM, which has a mark length unique for every optical disc 100, is formed by detecting the target edge length corresponding to the optical disc 100, the type of the optical disc 100 can be determined reliably.

Furthermore, since the optical disc apparatus 1 can detect the target edge length corresponding to the optical disc 100 only from the signal recording surface of the determination target disc, it is possible to check that the focal point of a light beam exists near the signal recording surface of the determination target disc.

Accordingly, the optical disc apparatus 1 can use the disc determination signal FOK_RF, which indicates that the signal recording surface of the determination target disc has been detected from the unknown disc 100x, as a signal indicating that start of a focus control is allowed. As a result, the optical disc apparatus 1 can reliably start the focus control with respect to the signal recording surface by starting the focus control when the disc determination signal FOK_RF is at a ‘High’ level.

### (2-4) Procedures

### (2-4-1) Determination Focus Control Start Processing

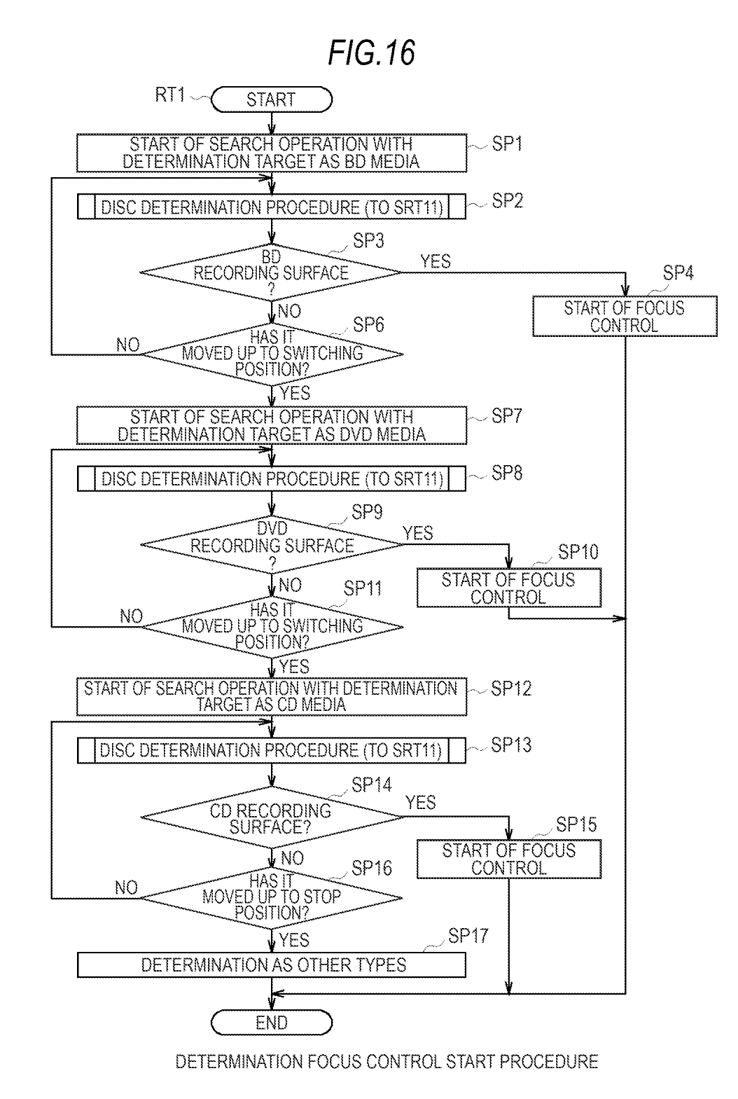

Next, procedures of determination focus control start processing executed according to a focus control start program and a media type determination program will be described using a flow chart shown in FIG. 16.

When the unknown disc 100x is loaded, the control unit 2 of the optical disc apparatus 1 starts a determination focus control start procedure RT1 (FIG. 16) and moves to step SP1.

In step SP1, the control unit 2 starts a search operation with a determination target disc as the BD media 100b by rotating the unknown disc 100x with the BD rotation number corresponding to the position of the objective lens 7 in the radial direction of the unknown disc 100 and at the same time, by illuminating the BD light beam Lb to the unknown disc 100x while moving the objective lens 7 in the focus direction. In addition, when generation of the focus error signal SRF and the reproduction signal SRFb is started on the basis of the returning BD light beam Lbr by the signal processing unit 10, the control unit 2 moves to the next step SP2.

In step SP2, the control unit 2 moves to subroutine SRT11. Then, when disc determination processing is executed by the signal processing unit 10, the control unit 2 moves to the next step SP3.

In step SP3, the control unit 2 determines whether or not a BD recording surface corresponding to the determination target disc has been detected from the unknown disc 100x on the basis of a result of the disc determination processing in step SP2.

When a positive result is obtained here, it means that a focal point of the BD light beam Lb is located near the BD recording surface of the BD media 100b. Accordingly, in this case, the control unit 2 moves to step SP4.

In step SP4, when the control unit 2 detects that the focal point of the BD light beam Lb has been formed on the BD recording surface of the BD media 100b and starts a focus control, the control unit 2 moves to an end step to finish the focus control start procedure RT1.

On the other hand, when a negative result is obtained in step SP3, the control unit 2 moves to step SP6 to determine whether or not the objective lens 7 has moved to the DVD switching position.

When a negative result is obtained here, it means that the BD light beam Lb has not reached the BD recording surface of the BD media 100b yet and the unknown disc 100x may be the BD media 100b. Accordingly, in this case, the control unit 2 returns to step SP2 to continue the processing in a state where the determination target disc is assumed to be the BD media 100b.

On the other hand, when a positive result is obtained in step SP6, it means that the unknown disc 100x is not the BD media 100b since the BD recording surface of the BD media 100b is not detected although the focal point of the BD light beam Lb has passed the position at which the BD recording surface of the BD media 100b should exist. In this case, the control unit 2 moves to step SP7.

In step SP7, the control unit 2 starts a search operation with the determination target disc as the DVD media 100d by rotating the unknown disc 100x with the DVD rotation number corresponding to the position of the objective lens 7 in the radial direction of the unknown disc 100x and at the same time, by illuminating a DVD light beam Ld to the unknown disc 100x while moving the objective lens 7 in the focus direction. In addition, when generation of the focus error signal SRF and the reproduction signal SRFb is started on the basis of the returning DVD light beam Ldr by the signal processing unit 10, the control unit 2 moves to the next step SP8.

In step SP8, the control unit 2 moves to subroutine SRT11. Then, when the disc determination processing is executed by the signal processing unit 10, the control unit 2 moves to the next step SP9.

In step SP9, the control unit 2 determines whether or not a DVD recording surface corresponding to the determination target disc has been detected from the unknown disc 100x on the basis of the disc determination processing in step SP8.

When a positive result is obtained here, it means that a focal point of the DVD light beam Ld is located near the DVD recording surface of the DVD media 100d. In this case, the control unit 2 moves to step SP10.

In step SP10, when the control unit 2 detects that the focal point of the DVD light beam Ld has been formed on the DVD recording surface of the DVD media 100d and starts a focus control, the control unit 2 moves to the end step to finish the focus control start procedure RT1.

On the other hand, when a negative result is obtained in step SP9, the control unit 2 moves to step SP11 to determine whether or not the objective lens 7 has moved to the DVD switching position.

When a negative result is obtained here, it means that the DVD light beam Ld has not reached the DVD recording surface of the DVD media 100d yet and the unknown disc 100x may be the DVD media 100d. Accordingly, in this case, the control unit 2 returns to step SP8 to continue the processing in a state where the determination target disc is assumed to be the DVD media 100d.

On the other hand, when a positive result is obtained in step SP11, it means that the unknown disc 100x is not the DVD media 100d. Accordingly, in this case, the control unit 2 moves to step SP12.

In step SP12, the control unit 2 starts a search operation with the determination target disc as the CD media 100c by rotating the unknown disc 100x with the CD rotation number corresponding to the position of the objective lens 7 in the radial direction of the unknown disc 100x and at the same time, by illuminating a CD light beam Lc to the unknown disc 100x while moving the objective lens 7 in the focus direction. In addition, when generation of the focus error signal SRF and the reproduction signal SRFc is started on the basis of the returning CD light beam Lcr by the signal processing unit 10, the control unit 2 moves to the next step SP13.

In step SP13, the control unit 2 moves to subroutine SRT11. Then, when the disc determination processing is executed by the signal processing unit 10, the control unit 2 moves to the next step SP13.

In step SP14, the control unit 2 determines whether or not a CD recording surface corresponding to the determination target disc has been detected from the unknown disc 100x on the basis of a result of the disc determination processing in step SP12.

When a positive result is obtained here, it means that a focal point of the CD light beam Lc is located near the CD recording surface of the CD media 100c. In this case, the control unit 2 moves to step SP15.

In step SP15, when the control unit 2 detects that the focal point of the CD light beam Lc has been formed on the CD recording surface of the CD media 100c and starts a focus control, the control unit 2 moves to the end step to finish the focus control start procedure RT1.

On the other hand, when a negative result is obtained in step SP14, the control unit 2 moves to step SP16 to determine whether or not the objective lens 7 has moved to the stop position.

When a negative result is obtained here, it means that the CD light beam Lc has not reached the CD recording surface of the CD media 100c yet and the unknown disc 100x may be the CD media 100c. Accordingly, in this case, the control unit 2 returns to step SP13 to continue the processing in a state where the determination target disc is assumed to be the CD media 100c.

On the other hand, when a positive result is obtained in step SP16, it means that the unknown disc 100x is not the CD media 100c. Accordingly, in this case, the control unit 2 moves to step SP17.

In step SP17, the control unit 2 determines that the unknown media 100x is not any of the BD media 100b, the DVD media 100d, and the CD media 100c but another type of optical disc 100 and moves the end step to finish the processing.

### (2-4-2) Disc Determination Processing by Counting of Target Edge Length

In steps SP2, SP8, and SP13 of the focus control start procedure RT1, the signal processing unit 10 of the optical disc apparatus 1 executes the subroutine SRT11, which indicates the disc determination procedure by counting of the target edge length, as the disc determination processing.

In step SP21 of subroutine SRT11, the signal processing unit 10 sets count values Cta to CTc, which indicate the number of data edge distances determined to be the target edge lengths Na to Nc, to ‘zero’. In addition, the signal processing unit 10 checks that a signal level of the disc determination signal FOK_RF is at a ‘Low’ level and moves to the next step SP22.

In step SP22, the signal processing unit 10 determines whether or not a signal level of the measurement timing signal FOK_PI is ‘High’.

When a positive result is obtained here, it means that the pull-in signal SPI is equal to or larger than a measurement threshold value and a focal point of a light beam may exist near the signal recording surface. Accordingly, in this case, the signal processing unit 10 moves to the next step SP24.

On the other hand, when a negative result is obtained in step SP22, it means that the focal point of a light beam is difficult to exist near the signal recording surface. Accordingly, in this case, the signal processing unit 10 waits until the signal level of the measurement timing signal FOK_PI rises to ‘High’ in step SP22.

In step SP24, the signal processing unit 10 starts measurement of the data edge distance and moves to the next step SP25.

In step SP25, the signal processing unit 10 determines whether or not the data edge distance under measurement is the target edge length Na. When a positive result is obtained, the signal processing unit 10 moves to step SP26 in which ‘1’ is added to the count value CTa, moving to the next step SP31.

On the other hand, when a negative result is obtained in step SP25, the signal processing unit 10 moves to step SP27 to determine whether or not the data edge distance under measurement is the target edge length Nb.

When a positive result is obtained here, the signal processing unit 10 moves to step SP28 in which ‘1’ is added to the count value CTb, moving to the next step SP31. On the other hand, when a negative result is obtained in step SP27, the signal processing unit 10 moves to step SP29.

In step SP29, the signal processing unit 10 determines whether or not the data edge distance under measurement is the target edge length Nc. When a positive result is obtained, the signal processing unit 10 moves to step SP30 in which ‘1’ is added to the count value CTc, moving to the next step SP31.

On the other hand, when a negative result is obtained in step SP29, it means that the data edge distance is not the target edge length. Accordingly, in this case, the signal processing unit 10 moves to step SP37.

In step SP31, the signal processing unit 10 determines whether or not all of the count values CTa, CTb, and CTc are equal to or larger than the appearance threshold value. On the other hand, when a positive result is obtained here, it means that the signal recording surface has been detected from the unknown disc 100x. Accordingly, in this case, the signal processing unit 10 moves to step SP32.

In step SP32, the signal processing unit 10 makes the disc determination signal FOK_RF rise from a ‘Low’ level to a ‘High’ level. Then, the signal processing unit 10 moves to the next step SP33.

In step SP33, the signal processing unit 10 determines whether or not the signal level of the measurement timing signal FOK_PI is at a ‘High’ level. When a positive result is obtained here, it means that the detection result of a signal recording surface can be sufficiently trusted since this was detected on the basis of the returning light beam with the sufficient light amount. Accordingly, in this case, the signal processing unit 10 moves to the next step SP34.

In step SP34, the signal processing unit 10 makes the disc determination signal FOK_RF rise from a ‘High’ level to a ‘Low’ level. Then, the signal processing unit 10 moves to the end step to finish the subroutine SRT11.

On the other hand, when a negative result is obtained in step SP31, it means that the target recording surface has not been detected yet because the count value CT is small. Accordingly, in this case, the signal processing unit 10 moves to step SP37.

In step SP37, the signal processing unit 10 determines whether or not the signal level of the measurement timing signal FOK_PI is at a ‘High’ level. On the other hand, when a positive result is obtained here, it means that the focal point of a light beam still exists near the signal recording surface. Accordingly, in this case, the signal processing unit 10 returns to step SP24 to continue the processing.

On the other hand, when a negative result is obtained in step SP37, the signal processing unit 10 moves to step SP39 to finish the subroutine SRT11.

### (2-5) Operations and Effects

In the above-described configuration, the optical disc apparatus 1 executes a search operation by rotating the unknown disc 100x, condensing the BD light beam Lb as a first light beam, which is emitted from the laser diode 6b as a light source and corresponds to the BD media 100b as a first optical disc, by the objective lens 7, illuminating it to the unknown disc 100x the type of which is unknown, and driving the objective lens 7 in the focus direction becoming distant from or approaching to the unknown disc 100x.

In addition, the optical disc apparatus 1 generates the reproduction signal SRFb as a first reproduction signal indicating the total amount of a returning light beam as a first returning light beam generated by reflection of the BD light beam Lb from the unknown disc 100x. In addition, using the binary reproduction data DRF generated from the reproduction signal SRFb, the optical disc apparatus 1 detects a BD recording surface as a first signal recording surface corresponding to the BD media 100b from the unknown disc 100x on the basis of the reproduction signal SRFb.

Accordingly, since the optical disc apparatus 1 can check the existence of the recording mark RM, which has a mark length unique to the BD recording surface, from the binary reproduction data DRF, the BD recording surface can be detected as a BD recording surface when the BD recording beam Lb exists near the BD recording surface without being confused by the existence of the fake pattern Pf.

In addition, the optical disc apparatus 1 determines that the unknown disc 100x is the BD media 100b when the BD recording surface is detected from the unknown disc. Thus, since the optical disc apparatus 1 can determine that the unknown media 100x is the BD media 100b only when the unknown media 100x certainly has the BD recording surface, the type of the unknown disc 100x can be determined with high precision.

Furthermore, when the BD recording surface is detected before the focal point of the BD light beam Lb reaches the BD recording surface, the optical disc apparatus 1 detects that the focal point of the BD light beam Lb has been formed on the BD recording surface and starts a control of the objective lens 7 in the focus direction by the control unit 2 as a focus control start section. Accordingly, since the optical disc apparatus 1 does not need to perform the search operation again, a time until reproduction and recording of information from the BD media 100d are started can be significantly shortened.

Furthermore, the optical disc apparatus 1 detects the BD recording surface on the basis of the data edge distance of the binary reproduction data DRF corresponding to a switching interval at which the signal level of the reproduction signal SRFb is switched between a ‘Low’ level lower than a reference level and a ‘High’ level higher than the reference level. In this case, the optical disc apparatus 1 is configured to detect the BD recording surface when the data edge distance as a target edge length corresponding to the mark length of the recording mark RM, which is to be formed on the BD recording surface, has been detected a number of times equal to or larger than a predetermined appearance threshold value.

Therefore, since the optical disc apparatus 1 recognizes that the BD recording surface has been detected when the data edge distance as a target edge length equal to or larger than the appearance threshold value, which is set to be detected naturally when the focal point of the BD light beam Lb exists near the BD recording surface, has been detected, the BD recording surface can be detected with high precision.

Moreover, the optical disc apparatus 1 is configured to detect the BD recording surface when all data edge distances as three target edge lengths corresponding to a plurality of switching intervals are detected a number of times equal to or larger than the appearance threshold value. Accordingly, the optical disc apparatus 1 can detect the BD recording surface with high precision compared with a case where a single target edge length is set.

Furthermore, the optical disc apparatus 1 sets data edge distances (2T, 3T, and 4T) with high frequencies of appearance among data edge distances as target edge lengths. Accordingly, since the optical disc apparatus 1 can detect a data edge distance as a target edge length in a short time, it is possible to shorten a time until a BD recording surface is detected.

In addition, the optical disc apparatus 1 condenses the DVD light beam Ld as a second light beam corresponding to the DVD media 10d, which is a second optical disc, and illuminates it to the unknown disc 100x. The optical disc apparatus 1 generates the reproduction signal SRFd as a second reproduction signal indicating the total amount of the returning DVD light beam Ldr as a second returning light beam generated by reflection of the DVD light beam Ld from the unknown disc 100x.

In addition, the optical disc apparatus 1 detects a DVD recording surface as a second signal recording surface, which corresponds to the DVD media 100d and on which the recording mark RM with a size different from that of the BD recording surface is formed, from the unknown disc 100x on the basis of the reproduction signal SRFd. Accordingly, the optical disc apparatus 1 can detect the DVD recording surface as well as the BD recording surface.

In addition, the optical disc apparatus 1 determines that the unknown disc 100x is the DVD media 100d when the DVD recording surface is detected from the unknown disc 100x. Thus, the optical disc apparatus 1 can determine whether the unknown disc 100x is the BD media 100b or the DVD media 10d.

The optical disc apparatus 1 moves the objective lens 7 in only one direction of the focus direction approaching the unknown disc 100x, performs switching between the BD light beam Lb and the DVD light beam Ld according to the position of the objective lens 7, that is, by movement of the objective lens 7 to the DVD switching position, and illuminates it to the unknown disc 100x.

Here, in a known optical disc apparatus, the thickness of a cover layer is detected by illuminating a light beam while moving an objective lens in a state where the optical disc 100 is not rotated (that is, the optical disc 100 is stopped) and the type of the optical disc 100 is determined on the basis of the thickness of the cover layer. Accordingly, in the known optical disc apparatus, it can be prevented that the thickness of the cover layer is erroneously recognized due to surface wobbling and the like.

That is, in the known optical disc apparatus, the objective lens 7 should be moved to the most distant position each time since a surface of the unknown disc 100x needs to be detected at the time of a search operation using the BD light beam Lb and the DVD light beam Ld.

In contrast, in the optical disc apparatus 1, it is sufficient to detect only the BD recording surface and the DVD recording surface, and the search operation can be started from the arbitrary position since it is not necessary to detect the surface of the unknown disc 100x. In addition, the positions of the BD recording surface and the DVD recording surface are different.

As a result, in the optical disc apparatus 1, by performing switching between the BD light beam Lb and the DVD light beam Ld at the DVD switching position, the search operation using the BD light beam Lb and the DVD light beam Ld can come to an end in a short time without driving the objective lens 7 uselessly.

In addition, the optical disc apparatus 1 condenses the CD light beam Lc as a third light beam corresponding to the CD media 100c, which is a third optical disc, and illuminates it to the unknown disc 100x. The optical disc apparatus 1 generates the reproduction signal SRFc as a third reproduction signal indicating the total amount of the returning CD light beam Lcr generated by reflection of the CD light beam Lc from the unknown disc 100x.

In addition, the optical disc apparatus 1 detects a CD recording surface, which corresponds to the CD media 100c and on which the recording mark RM with a size different from those of the BD recording surface and the DVD recording surface is formed, from the unknown disc 100x on the basis of the reproduction signal SRFc. Accordingly, the optical disc apparatus 1 can detect the CD recording surface as well as the BD recording surface and DVD recording surface.

The optical disc apparatus 1 determines that the unknown disc 100x is the CD media 100c when the CD recording surface is detected from the unknown disc 100x. Thus, the optical disc apparatus 1 can determine whether the unknown disc 100x is the BD media 100b, the DVD media 100d, or the CD media 100c.

Furthermore, in the optical disc apparatus 1, the unknown disc 100x is rotated with the BD rotation number corresponding to the BD media 100b when illuminating the BD light beam Lb to the unknown disc 100x. The optical disc apparatus 1 rotates the unknown disc 100x with the DVD rotation number corresponding to the DVD media 100d when illuminating the DVD light beam Ld to the unknown disc 100x. The optical disc apparatus 1 rotates the unknown disc 100x with the CD rotation number corresponding to the CD media 100c when illuminating the CD light beam Lc to the unknown disc 100x.

That is, since the optical disc apparatus 1 rotates the unknown disc 100x with the number of rotations corresponding to each optical disc 100, a servo control can be quickly started without changing the number of rotations after the signal recording surface is detected.

In addition, the optical disc apparatus 1 has the objective lens 7 which makes the BD light beam Lb illuminated to the BD recording surface of the BD media 100b by condensing to the focal point of the BD light beam Lb and which makes the DVD light beam Ld illuminated to the DVD recording surface of the DVD media 100d by condensing to the focal point of the DVD light beam.

In the optical disc apparatus 1, a condensing point of the unused light U is reflected on the surface of the unknown disc 100x because the objective lens 7 acts as a wavelength selective multifocal lens. As a result, the fake pattern Pf is generated in the pull-in signal SPI or the focus error signal SFE. However, since the optical disc apparatus 1 detects a signal recording surface by detecting the recording mark RM which exists uniquely for each optical disc 100, the signal recording surface can be reliably detected without being confused by the fake pattern Pf.

According to the above-described configuration, the optical disc apparatus 1 detects a signal recording surface on the basis of the reproduction signal SRF. Therefore, the optical disc apparatus 1 can detect a signal recording surface by detecting the recording mark RM, which exists uniquely for each optical disc 100, from each optical disc 100. In this way, an optical disc apparatus and a signal recording surface detecting method capable of detecting a signal recording surface correctly can be realized.

### (2-6) Other Embodiments

In the first embodiment, the case where the objective lens 7 is moved in the direction of the focus direction approaching the unknown disc 100x has been described. However, the present invention is not limited thereto. In the first embodiment of the present invention, the objective lens 7 may also be moved in a direction becoming distant from the unknown disc 100x.

Furthermore, in the first embodiment, the case where switching to the DVD light beam Ld and the CD light beam Lc is performed when the objective lens 7 moves up to the DVD switching position and the CD switching position while moving the objective lens 7 in an approaching direction (one direction) approaching the unknown disc 100x has been described. However, the present invention is not limited thereto. In the first embodiment of the present invention, for example, it is also possible to stop the objective lens 7 temporarily at the DVD switching position and the CD switching position and to move the objective lens 7 again after the number of rotations of the unknown disc 100x is stabilized to the DVD rotation number and the CD rotation number.

Accordingly, in the first embodiment of the present invention, the focus control can be started by detecting the DVD recording surface and the CD recording surface when the number of rotations of the unknown disc 100x is stabilized to the DVD rotation number and the CD rotation number.

Moreover, in the first embodiment of the present invention, the objective lens 7 may be moved temporarily up to the DVD switching position in a distant direction (the other direction) becoming distant from the unknown disc 100x after moving the objective lens 7 up to a predetermined illumination stop position while illuminating the BD light beam Lb to the unknown disc 100x, and the objective lens 7 may be moved in the approaching direction again while illuminating the DVD light beam Ld from the switching position to the unknown disc 100x. Moreover, the same is true for the CD light beam Lc.

Thus, in the first embodiment of the present invention, a search range for a DVD recording surface and a CD recording surface can be extended. Accordingly, even if the positions of the DVD recording surface and the CD recording surface are changed due to surface wobbling and the like, the DVD recording surface and the CD recording surface can be reliably detected.

Furthermore, in the first embodiment, the case where the data edge distance corresponding to a switching period is detected corresponding to the rising edge and the falling edge of the binarization signal DRF has been described. However, the present invention is not limited thereto. In the first embodiment of the present invention, for example, the switching period may be detected by detecting a zero cross point of the reproduction signal SRF.

Furthermore, in the first embodiment, the case where values obtained by increasing and decreasing ±10% as an error range with respect to the target edge length are set as a target threshold range has been described. However, the present invention is not limited thereto. The error range may be set as any value.

Furthermore, in the first embodiment, the case where it is recognized that a signal recording surface has been detected (that is, checked) formally when both the disc determination signal FOK_RF and the measurement timing signal are at ‘High’ levels and the recording surface check signal FOK is made to rise to a ‘High’ level has been described. However, the present invention is not limited thereto. It may be possible to recognize that the signal recording surface has been detected formally when only the disc determination signal FOK_RF is at a ‘High’ level and to make the recording surface check signal FOK rise to a ‘High’ level.

Furthermore, in the first embodiment, the case where a signal recording surface is detected when data edge distances corresponding to three target edges have been detected a number of times equal to or larger than the appearance threshold value has been described. However, the present invention is not limited thereto. One target edge, two target edges, or four or more target edges may be set. It is needless to say that all data edge distances may be set as target edges. In this case, an appearance threshold value may be set as a different value for every target edge according to the appearance probability of the target edge. This can prevent detection of a signal recording surface from being delayed according to a target edge with the low appearance probability.

Furthermore, in the first embodiment, the case where a data edge distance with the high appearance probability is set as the target edge has been described. However, the present invention is not limited thereto. In first embodiment of the present invention, an arbitrary data edge distance may be set as the target edge.

Furthermore, in the first embodiment, the case where a change according to the recording mark RM does not occur in the surface fake pattern PSf in the reproduction signal SRF has been described. However, also in a reflection fake pattern PRf, the same effects can be obtained since a change according to the recording mark RM is difficult to appear correctly due to a difference in a spot diameter.

Furthermore, in the first embodiment, the case where the optical disc apparatus 1 supports the three optical discs 100 of the BD media 100b, the DVD media 100d, and the CD media 100c has been described. However, the present invention is not limited thereto. The present invention may be applied to an optical disc apparatus which supports one type, two types, or four or more types of optical discs 100.

Furthermore, in the first embodiment, the case where the objective lens 7 is a wavelength selective multifocal lens corresponding to three wavelengths of the BD light beam Lb, the DVD light beam Ld, and the CD light beam Lc has been described. However, the present invention is not limited thereto. For example, it is possible to have two objective lenses of a first objective lens, which condenses the BD light beam Lb, and a second objective lens, which condenses the DVD light beam Ld, as objective lenses. Also in this case, the same effects as in the above-described present embodiment can be obtained.

Furthermore, in the first embodiment, the case where the objective lens 7 has three numerical apertures has been described. However, the present invention is not limited thereto. For example, the objective lens 7 may have two numerical apertures or four or more numerical apertures.

Furthermore, in the first embodiment, the case where the type of an optical disc is determination in order of the BD media 100b, the DVD media 100d, and the CD media 100c has been described. However, the present invention is not limited thereto, but the type of an optical disc may be determined in various orders.

Furthermore, in the first embodiment, the case where the determination focus control start processing is executed when the unknown disc 100x is loaded has been described. However, the present invention is not limited thereto. The invention may be executed at arbitrary timing, for example, when a power source is switched to ‘ON’ in a state where the unknown disc 100x is loaded.

Furthermore, in the first embodiment, the case where the objective lens 7 supports three wavelengths of a CD wavelength 780 [nm], a DVD wavelength 660 [nm], and a BD wavelength 405 [mm] has been described. However, the present invention is not limited thereto, but the objective lens 7 may support various wavelengths.

Furthermore, in the first embodiment, the case where the laser diode 6 is configured to include the CD laser diode 6c, the DVD laser diode 6d, and the BD laser diode 6b each of which emits a laser beam with a single wavelength has been described. However, the present invention is not limited thereto. In the first embodiment of the present invention, as the laser diode 6, for example, a two-wavelength support laser diode capable of emitting light beams with two kinds of wavelengths for CD/DVD and the BD laser diode 6b may be combined, or a three-wavelength support laser diode capable of emitting light beams with three kinds of wavelengths for CD/DVD/BD may be used.

Furthermore, in the first embodiment, the case where the optical disc apparatus 1 records information on the optical disc 100 and reproduces the information from the optical disc 100, that is, performs both recording and reproduction has been described. However, the present invention is not limited thereto. For example, the present invention may also be applied to a case where the optical disc apparatus 1 is an optical disc reproduction apparatus that performs only reproduction of information or a case where the optical disc apparatus 1 is an optical disc recording apparatus that performs only recording of information. Furthermore, the present invention may also be applied to a case where the optical disc apparatus 1 performs both recording and reproduction for the CD media 100c and the DVD media 100d and performs only reproduction for the BD media 100b.

Furthermore, in the first embodiment, the case where the objective lens 7 as an objective lens, the actuator 8 as a driving section, the spindle motor 4 as a rotation section, and the signal processing unit 10 as a signal processing section and a detecting section form the optical disc apparatus 1 as an optical disc apparatus has been described. However, the present invention is not limited thereto, but the optical disc apparatus according to the embodiment of the present invention may also be formed by an objective lens, a driving section, a rotation section, a signal processing section, and a detecting section with other configurations.

### (3) Second Embodiment

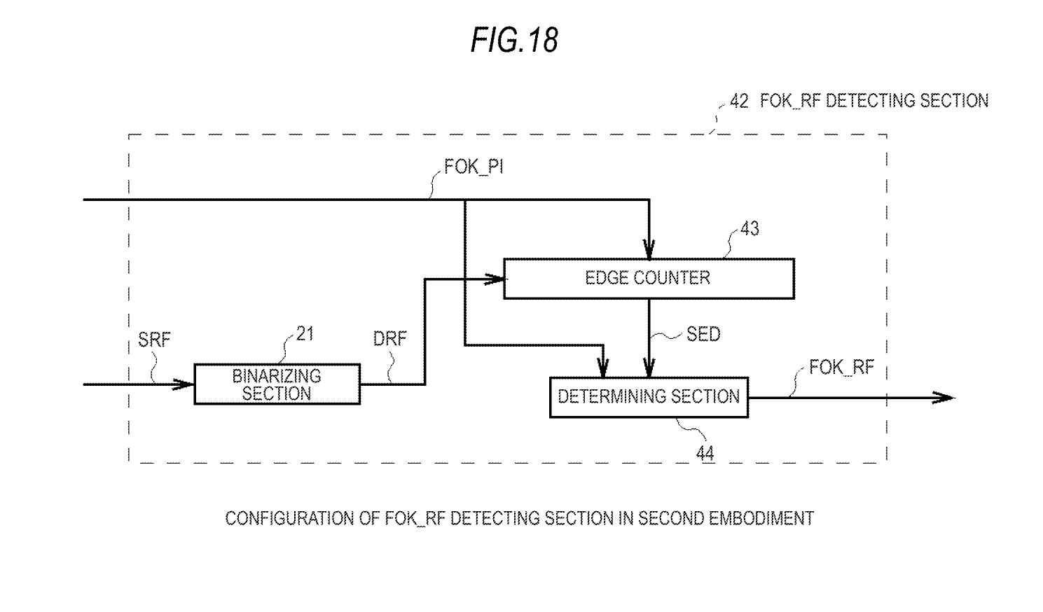

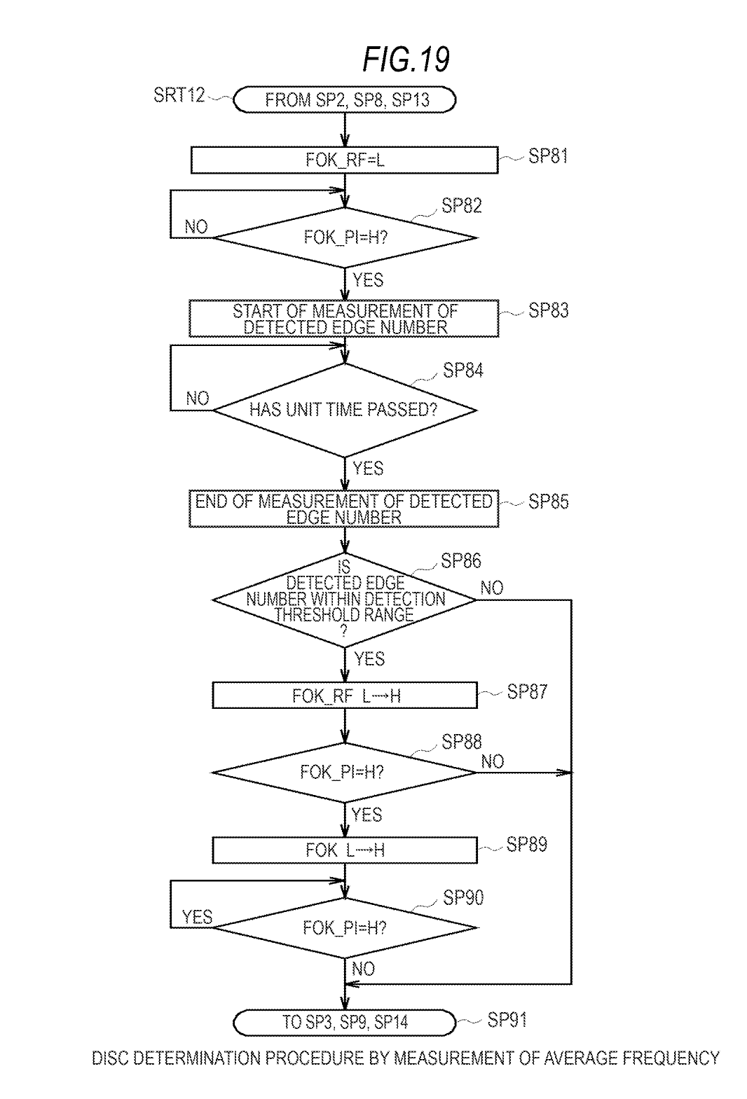

FIGS. 18 and 19 show a second embodiment, and sections corresponding to the first embodiment which are shown in FIGS. 4 to 17 are denoted by the same reference numerals. In the second embodiment, processing details of disc determination processing are different from those in the first embodiment. In addition, since an optical disc apparatus 41 in the second embodiment has approximately the same configuration as the optical disc apparatus 1 in the first embodiment, an explanation on the optical disc apparatus 41 will be omitted. In addition, the optical disc apparatus 41 executes determination focus control start processing according to the determination focus control start procedure RT1 (FIG. 16), similar to the first embodiment.

### (3-1) Disc Determination Processing by Average Frequency Measurement

Here, in disk formats, such as the BD media 100b, the DVD media 100d, and the CD media 100c, information is recorded after performing scramble processing, modulation processing, and the like on the information. Accordingly, the appearance probability of the edge length is almost equal all the time irrespective of the contents of information. In other words, an average value (hereinafter, referred to as an edge distance average value) of appearing data edge distances is almost fixed for every type of optical disc 100.

As shown in FIG. 10, a value obtained by dividing a SUM value (5138751. 35 [nsec]) of ‘Average*Number’ indicating a sum value of the appearance time of the edge length by a SUM value (99816) of ‘Number’ indicating the number of samples becomes an edge distance average value. As a result, when the BD media 100b is made to rotate at the normal speed, the edge distance average value becomes 51.48 [nsec].

In addition, as shown in FIG. 11, a SUM value of ‘Avarage*Number’ is 9063761 [nsec], and a SUM value of ‘Number’ is 99990. From this, when the DVD media 100d is made to rotate at the double speed, the edge distance average value becomes 90.65 [nsec].

In addition, as shown in FIG. 12, a SUM value of ‘Avarage*Number’ is 28172905 [nsec], and a SUM value of ‘Number’ is 99759. From this, when the CD media 100c is made to rotate at the quad speed, the edge distance average value becomes 282.41 [nsec].

From these values, it can be seen that the edge distance average value is different for every type of optical disc 100. That is, in the disc determination processing, it is possible to detect a BD recording surface, a DVD recording surface, or a CD recording surface from the unknown disc 100x on the basis of an average value of data edge distances.

Here, if the edge distance average value is small, the number (hereinafter, referred to as a detected edge number) of data edges detected per unit time (that is, rising edge and falling edge in the binary reproduction data SRF) is increased. On the other hand, if the edge distance average value is large, the detected edge number is decreased.

Accordingly, the optical disc apparatus 41 determines the type of the optical disc 100 by measuring the detected edge number per unit time.

Specifically, the signal processing unit 10 of the optical disc apparatus 41 executes disc determination processing by an FOK_RF detecting section 42 corresponding to the FOK_RF detecting section 12 as shown in FIG. 18. The FOK_RF detecting section 42 starts counting of a data edge with an edge counter 43 when the measurement timing signal FOK_PI rises from a ‘Low’ level to a ‘High’ level since the pull-in signal SPI has become a predetermined measurement threshold value or more.

When the edge counter 43 counts a detected edge number, for example, for 50 [μsec] as a unit time, the edge counter 43 supplies to a determining section 44 an edge number signal SED indicating the detected edge number.

Here, when measuring the detected edge number for 50 [μsec], for example, about 971 obtained by dividing 50 [μsec] by the edge distance average value (51.48 [nsec]) becomes the number of reference edges to be detected theoretically from the BD media 100b (normal speed).

If ±10% of error is increased or decreased with respect to 971, 870 to 1070 (870 or more and 1070 or less) is obtained. This value is set to a detection threshold range for determining whether or not the corresponding media is the BD media 100b.

Similarly, when measuring the detected edge number for 50 [μsec], the number of reference edges of the DVD media 100d (double speed) becomes 552 and the number of reference edges of the CD media 100c (quad speed) becomes 177. Accordingly, 497 to 607 and 159 to 195 obtained by increase and decrease of ±10% of error become detection threshold ranges of the DVD media 100d and the CD media 100c, respectively.

The determining section 44 makes the disc determination signal FOK_RF rise from a ‘Low’ level to a ‘High’ level when the detected edge number indicated by the edge number signal SED is determined to be within the detection threshold range corresponding to the determination target media.

When the disc determination signal FOK_RF rises to a ‘High’ level, the FOK detecting section 15 (FIG. 7) determines whether the measurement timing signal FOK_PI is ‘High’. When the measurement timing signal FOK_PI is ‘High’, the FOK detecting section 15 makes the recording surface check signal FOK rise from a ‘Low’ level to a ‘High’ level.

Thus, using the fact that the edge distance average value is almost constant in each optical disc 100, the optical disc apparatus 41 determines that a signal recording surface corresponding to the determination target disc has been detected from the unknown disc 100x when the detected edge number per unit time is within the detection threshold range of the determination target disc.

Accordingly, since the optical disc apparatus 41 can reliably determine whether or not the unknown disc 100x is the determination target disc in a predetermined unit time, a preparation time before the focus control is started can be sufficiently secured.

### (3-2) Procedures

Next, procedures of disc determination processing executed according to a media type determination program will be described using a flow chart shown in FIG. 19.

In steps SP2, SP8, and SP13 of the focus control start procedure RT1, the signal processing unit 10 of the optical disc apparatus 41 executes, as disc determination processing, a subroutine SRT12 indicating a disc determination procedure using average frequency measurement.

In step SP81 of the subroutine SRT12, the signal processing unit 10 checks that a signal level of the disc determination signal FOK_RF is at a ‘Low’ level, moving to the next step SP82.

In step SP82, the signal processing unit 10 determines whether the signal level of the measurement timing signal FOK_PI is ‘High’.

When a positive result is obtained here, a focal point of a light beam exists near a signal recording surface 101 since the pull-in signal SPI is equal to or larger than a measurement threshold value. Accordingly, the signal processing unit 10 moves to the next step SP83.

On the other hand, when a negative result is obtained in step SP82, the focal point of a light beam does not exist near the signal recording surface 101. Accordingly, the signal processing unit 10 waits until a signal level of the measurement timing signal FOK_PI rises to ‘High’ in step SP82.

In step SP83, the signal processing unit 10 starts measurement of a detected edge number. Then, the signal processing unit 10 moves to the next step SP84.

In step SP84, the signal processing unit 10 determines whether or not the unit time has passed. The signal processing unit 10 moves to the next step SP85 when a positive result is obtained, while the signal processing unit 10 continues measurement of the detected edge number in step SP84 when a negative result is obtained.

In step SP85, the signal processing unit 10 ends measurement of the detected edge number. Then, the signal processing unit 10 moves to the next step SP86.

In step SP86, the signal processing unit 10 determines whether or not the detected edge number is within the detection threshold range. When a negative result is obtained here, it means that the focal point of a light beam does not exist near a signal recording surface of a determination target disc. In this case, the signal processing unit 10 moves to step SP91 to finish the subroutine SRT12.

On the other hand, when a positive result is obtained in step SP86, it means that the focal point of a light beam exists near the signal recording surface of the determination target disc. In this case, the signal processing unit 10 moves to the next step SP87.

In step SP87, the signal processing unit 10 makes the disc determination signal FOK_RF rise from a ‘Low’ level to a ‘High’ level, moving to the next step SP88.

In step SP88, the signal processing unit 10 determines whether or not the signal level of the measurement timing signal FOK_PI is ‘High’. When a negative result is obtained, the signal processing unit 10 recognizes that measurement of the detected edge number may not be correct because the amount of light is not sufficient, moving to step SP91 to finish the subroutine SRT12.

On the other hand, when a positive result is obtained in step SP88, the signal processing unit 10 moves to step SP89 to make the recording surface check signal FOK rise from a ‘Low’ level to a ‘High’ level, moving to the next step SP90.

In step SP90, the signal processing unit 10 determines whether or not the measurement count signal FOK_PI is at a ‘High’ level. When a positive result is obtained, the signal processing unit 10 waits until a negative result is obtained in step SP90.

On the other hand, when a negative result is obtained in step SP90, the signal processing unit 10 moves to the next step SP91 to finish the subroutine SRT12.

### (3-3) Operations and Effects

In the above-described configuration, the optical disc apparatus 41 detects the BD recording surface on the basis of the average frequency of the reproduction signal SRF by measuring the detected edge number which is the number of rising edges and falling edges per unit time in the binarization reproduction signal DRF.

Accordingly, since the optical disc apparatus 41 can detect the BD recording surface on the basis of the frequency of the reproduction signal SRFb which changes with the length of the recording mark RM, the BD recording surface can be reliably detected as a BD recording surface on the basis of the mark length of the recording mark RM formed on the BD recording surface without being confused by the fake pattern Pf and the like.

In addition, the optical disc apparatus 41 detects the BD recording surface when the detected edge number of the binary reproduction data DRF, which is detected in a predetermined unit time and corresponds to the switching timing at which the signal level of the reproduction signal SRFb switches to the ‘Low’ level and the ‘High’ level, is within the predetermined detection threshold range.

Accordingly, since the optical disc apparatus 41 can finish the measurement reliably in the unit time after the measurement timing signal FOK_PI rises and determine whether or not the focal point of the BD light beam Lb exists near the BD recording surface, it can be finished within a predetermined time whether or not the BD recording surface has been detected. For this reason, since the optical disc apparatus 41 can reliably determine whether or not the BD recording surface has been detected before the focal point of the BD light beam Lb reaches the BD recording surface, the focus control can be quickly started for the BD recording surface.

According to the above-described configuration, the optical disc apparatus 41 can detect a signal recording surface on the basis of the average length of the recording mark RM in each optical disc 100 by detecting the signal recording surface on the basis of the frequency of the reproduction signal SRF. In this way, the optical disc apparatus 41 can detect the signal recording surface correctly.

### (3-4) Other Embodiments

In the second embodiment, the case where a range obtained by increase and decrease of an error range of ±10% of the number of reference edges to be detected is set as a detection threshold range has been described. However, the present invention is not limited thereto. The error range that increases and decreases with respect to the number of reference edges can be set as an arbitrary value.

Furthermore, in the second embodiment, the case where a detection edge is measured as the switching timing has been described. However, the present invention is not limited thereto. In second embodiment of the present invention, for example, the zero cross point may be measured from the reproduction signal SRF. Even in this case, the same effects as in the above-described embodiment can be obtained.

### (4) Third Embodiment

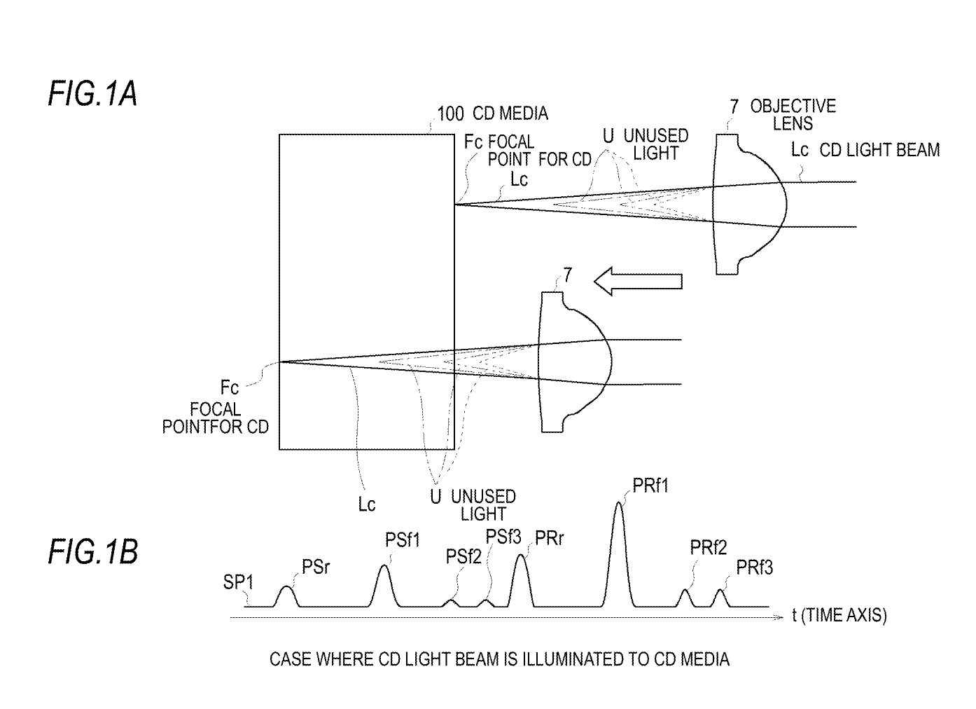

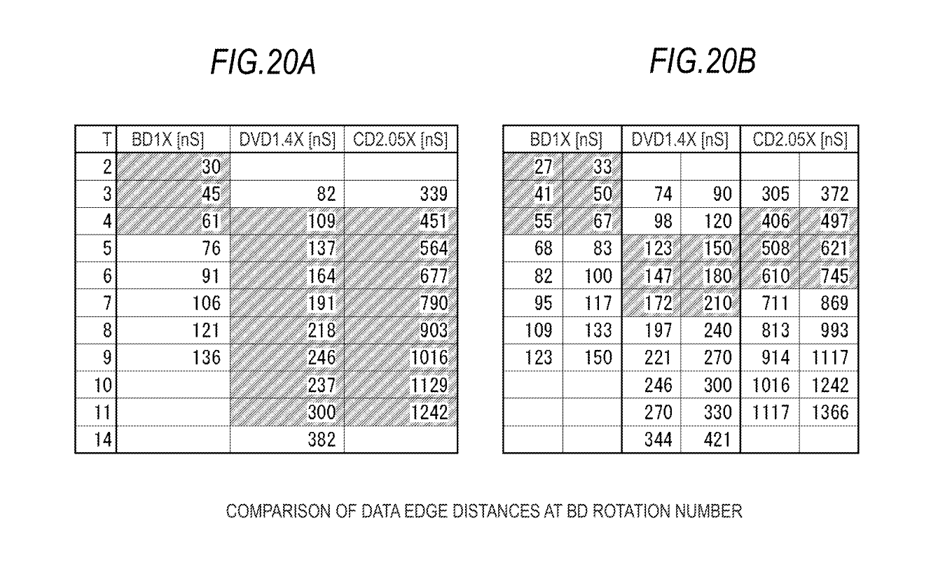

FIGS. 20A to 22 show a third embodiment, and sections corresponding to the first embodiment which are shown in FIGS. 1A to 17 are denoted by the same reference numerals. In addition, since an optical disc apparatus 51 in the third embodiment has approximately the same configuration as the optical disc apparatus 1 in the first embodiment, an explanation on the optical disc apparatus 51 will be omitted.

### (4-1) Media Type Determination

The optical disc apparatus 51 supports a hybrid media 100h having three signal recording surfaces of a BD recording surface, a DVD recording surface, and a CD recording surface as well as the BD media 100b, the DVD media 100d, and the CD media 100c described above.

Although not shown, the hybrid media 100h has a BD recording surface at a position of about 0.1 [mm] from an incidence surface (top surface) of a light beam, a DVD recording surface at a position of about 0.6 [mm] from the incidence surface, and a CD recording surface at a position of about 1.2 [mm] from the incidence surface.

In the optical disc apparatus 51, the objective lens 7 is moved at a fixed moving speed from a most distant position to a stop position while rotating the unknown disc 100x with one rotation number. Then, when a single or a plurality of signal recording surfaces are detected from the unknown disc 100x, the type of the unknown disc 100x is determined on the basis of the detection result.

Specifically, for example, when the unknown disc 100x is loaded, the control unit 2 of the optical disc apparatus 51 first sets the BD media 100b as a determination target disc and executes a search operation. In practice, the control unit 2 rotates the unknown disc 100x with the BD rotation number and at the same time, moves the objective lens 7 at a predetermined moving speed in a direction bringing the objective lens 7 close to the unknown disc 100x from the most distant position while illuminating the BD light beam Lb. In this case, similar to the first embodiment, the control unit 2 executes disc determination processing by the signal processing unit 10 when the pull-in signal SPI becomes equal to or larger than a measurement threshold value.

The control unit 2 executes a search operation with a DVD media as a determination target disc when the recording surface check signal FOK indicating that the BD recording surface has been checked is supplied or the objective lens 7 is moved up to the DVD switching position as a result of the disc determination processing. In practice, the control unit 2 rotates the unknown disc 100x with the BD rotation number while moving the objective lens 7 at the moving speed and at the same time, switches the illuminated light beam to the DVD light beam Ld. At this time, the control unit 2 executes the disc determination processing in the same manner as when the BD media 100c is set as a determination target disc.

The control unit 2 executes a search operation with a CD media as a determination target disc when the recording surface check signal FOK indicating that the DVD recording surface has been checked rises to a ‘High’ level or the objective lens 7 is moved up to the CD switching position as a result of the disc determination processing. In practice, the control unit 2 rotates the unknown disc 100x with the BD rotation number while moving the objective lens 7 at the moving speed and at the same time, switches the illuminated light beam to the CD light beam Lc. At this time, the control unit 2 executes the disc determination processing in the same manner as when the BD media 100c is set as a determination target disc.

In addition, the control unit 2 executes a search operation when the recording surface check signal FOK indicating that the CD recording surface has been checked rises to a ‘High’ level or the objective lens 7 is moved up to the stop position as a result of the disc determination processing.

Then, the control unit 2 determines the type of the unknown disc 100x on the basis of the recording surface check signal FOK supplied during the search operation.

At this time, since only the BD recording surface was detected in case where the recording surface check signal FOK rose to the ‘High’ level only when the BD media 100b was set as a determination target disc, the control unit 2 determines that the unknown disc 100x is the BD media 100b.

On the other hand, since the DVD recording surface was detected in case where the recording surface check signal FOK rose to the ‘High’ level only when the DVD media 100d was set as a determination target disc, the control unit 2 determines that the unknown disc 100x is the DVD media 100d.

On the other hand, since only the CD recording surface was detected in case where the recording surface check signal FOK rose to the ‘High’ level only when the CD media 100c was set as a determination target disc, the control unit 2 determines that the unknown disc 100x is the CD media 100c.

On the other hand, since the BD recording surface, the DVD recording surface, and the CD recording surface were detected in case where the recording surface check signal FOK rose to the ‘High’ level when the BD media 100b, the DVD media 100d, and the CD media 100c were set as determination target discs, the control unit 2 determines that the unknown disc 100x is the hybrid media 100h.

Thus, the optical disc apparatus 51 moves a light beam from the incidence surface of the unknown disc 100x to an opposite surface, which is an opposite side to the incidence surface, while switching the light beam in order to determine whether or not a BD recording surface, a DVD recording surface, and a CD recording surface exist in the unknown disc 100x.

Accordingly, since the optical disc apparatus 51 can reliably detect each signal recording surface irrespective of the existence of the fake pattern Pf, the type can be correctly determined for any of the optical disc 100 having a plurality of types of signal recording surfaces and the optical disc 100 having a single type of signal recording surface.

### (4-2) Start of Focus Control

The optical disc apparatus 51 starts a focus control with respect to a desired signal recording surface, for example, when a request to execute reproduction or recording of information is made. A case where the focus control is started with respect to a DVD recording surface, for example, in the hybrid disk 100h will be described as an example.

The control unit 2 of the optical disc apparatus 51 sets a DVD recording surface, which is a target of recording or reproduction of information, as a determination target recording surface and executes a search operation corresponding to the DVD recording surface. In practice, the control unit 2 rotates the hybrid media 100h with the DVD rotation number and at the same time, moves the objective lens 7 at a predetermined moving speed in a direction bringing the objective lens 7 close to the hybrid media 100h from a predetermined position while illuminating the DVD light beam Ld.

In this case, similar to the media type determination processing, the control unit 2 executes disc determination processing by the signal processing unit 10 when the pull-in signal SPI becomes equal to or larger than a measurement threshold value.

Then, when the recording surface check signal FOK indicating that the DVD recording surface has been checked by the disc determination processing is supplied, the control unit 2 starts the focus control at the position at which the DVD light beam Ld has been focused on the DVD recording surface.

Thus, the optical disc apparatus 51 starts the focus control with respect to a signal recording surface after determining that a signal recording surface located near the focal point of a light beam is a determination target recording surface by disc determination processing.

Accordingly, even in the case where the optical disc 100 is the hybrid media 100h having a plurality of types of signal recording surfaces, the optical disc apparatus 51 can the start focus control after checking the type of the signal recording surface. For this reason, it can be reliably prevented that the optical disc apparatus 51 starts the focus control with respect to different types of signal recording surfaces.

### (4-3) Disc Determination Processing

Here, the BD rotation number at the normal speed is equivalent to about 1.4 times the DVD rotation number (normal speed). Similarly, the BD rotation number at the normal speed is equivalent to about 2.05 times the CD rotation number (normal speed). An edge data distance of each edge length in the binary reproduction data DRF in this case is shown in FIG. 20A. Moreover, it is shown by diagonal lines that values of the edge data distance are not equal to those of another type of optical discs 100.

The optical disc apparatus 51 sets an edge length, which has an edge data distance not equal to that of another type of optical disc 100, as a target edge length, so that it can be prevented more reliably that the signal recording surface is erroneously recognized.

Specifically, the optical disc apparatus 51 sets 2T, 3T, and 4T as the target edge length N for the BD media 100b, sets 5T, 6T, and 7T as the target edge length N for the DVD media 100d, and sets 4T, 5T, and 6T as the target edge length N for the CD media 100c.

That is, in the case of the BD media 100b, values obtained by increase and decrease of 10% with respect to values (Na: 2T=30 [nsec], Nb: 3T=45 [nsec], Nc: 4T=61 [nsec]) of the target edge length N are set as a target threshold range corresponding to the target edge length N. In addition, the target threshold range becomes values (Na: 27 and 33 [nsec], Nb: 41 and 50 [nsec], Nc: 55 and 67 [nsec]) shown by diagonal lines in FIG. 20B.

That is, in the case of the DVD media load, values obtained by increase and decrease of 10% with respect to values (Na: 5T=137 [nsec], Nb: 6T=164 [nsec], Nc: 7T=191 [nsec]) of the target edge length N are set as a target threshold range corresponding to the target edge length. In addition, the target threshold range becomes values (Na: 123 and 150 [nsec], Nb: 147 and 180 [nsec], Nc: 172 and 210 [nsec]) shown by diagonal lines in FIG. 20B.

That is, in the case of the CD media 100c, values obtained by increase and decrease of 10% with respect to values (Na: 4T=451 [nsec], Nb: 5T=564 [nsec], Nc: 6T=677 [nsec]) of the target edge length N are set as a target threshold range corresponding to the target edge length. In addition, the target threshold range becomes values (Na: 406 and 497 [nsec], Nb: 508 and 621 [nsec], Nc: 610 and 745 [nsec]) shown by diagonal lines in FIG. 20B.

In addition, the optical disc apparatus 51 can reliably detect a BD recording surface, a DVD recording surface, and a CD recording surface by executing the disk determination processing similar to the first embodiment.

### (4-4) Procedures

### (4-4-1) Media Type Determination Procedure

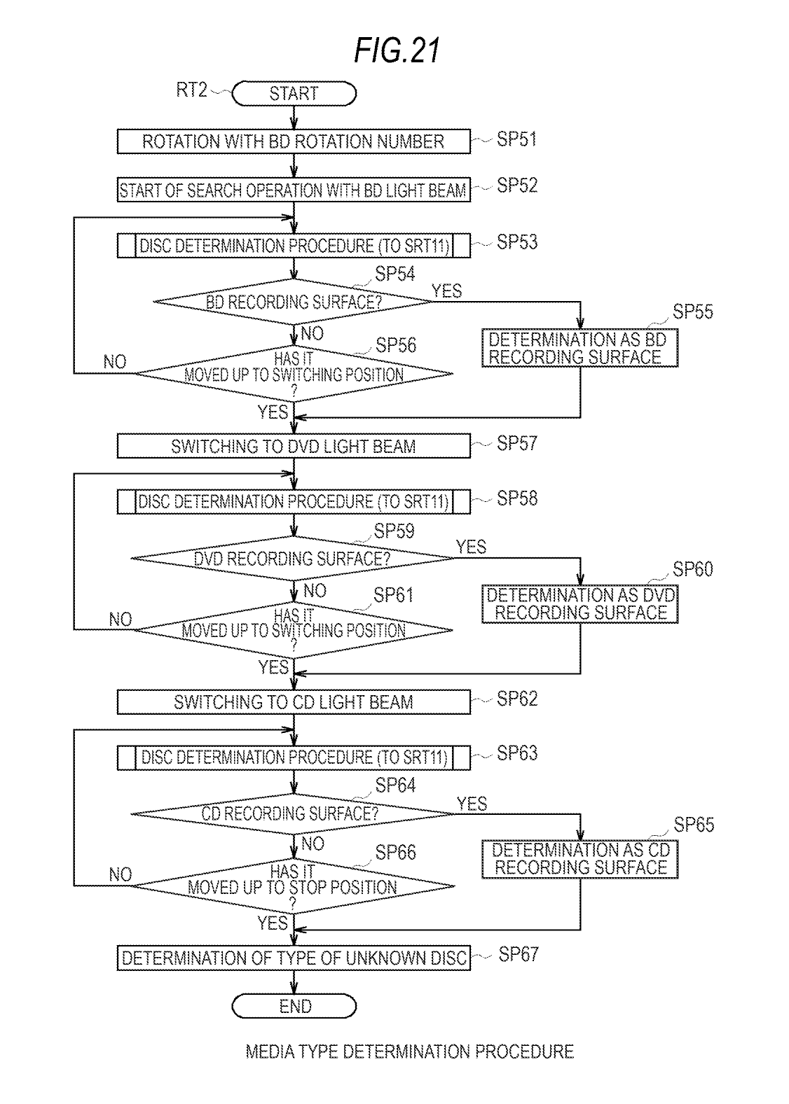

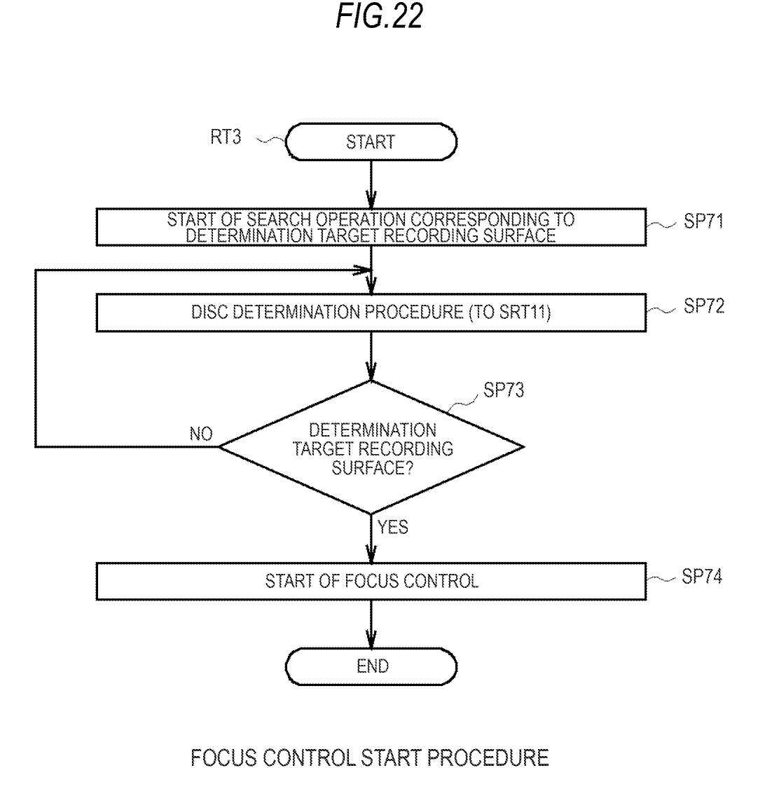

Next, a media type determination procedure RT2 executed according to a media type determination program will be described using a flow chart shown in FIG. 21.

The control unit 2 of the optical disc apparatus 51 starts the media type determination procedure RT2, for example, when the unknown disc 100x is loaded, and moves to step SP51.

In step SP51, the control unit 2 rotates the unknown disc 100x with the BD rotation number, moving to the next step SP52. In step SP52, the control unit 2 starts a search operation by moving the objective lens 7 while illuminating the BD light beam Lb, moving to the next step SP53.

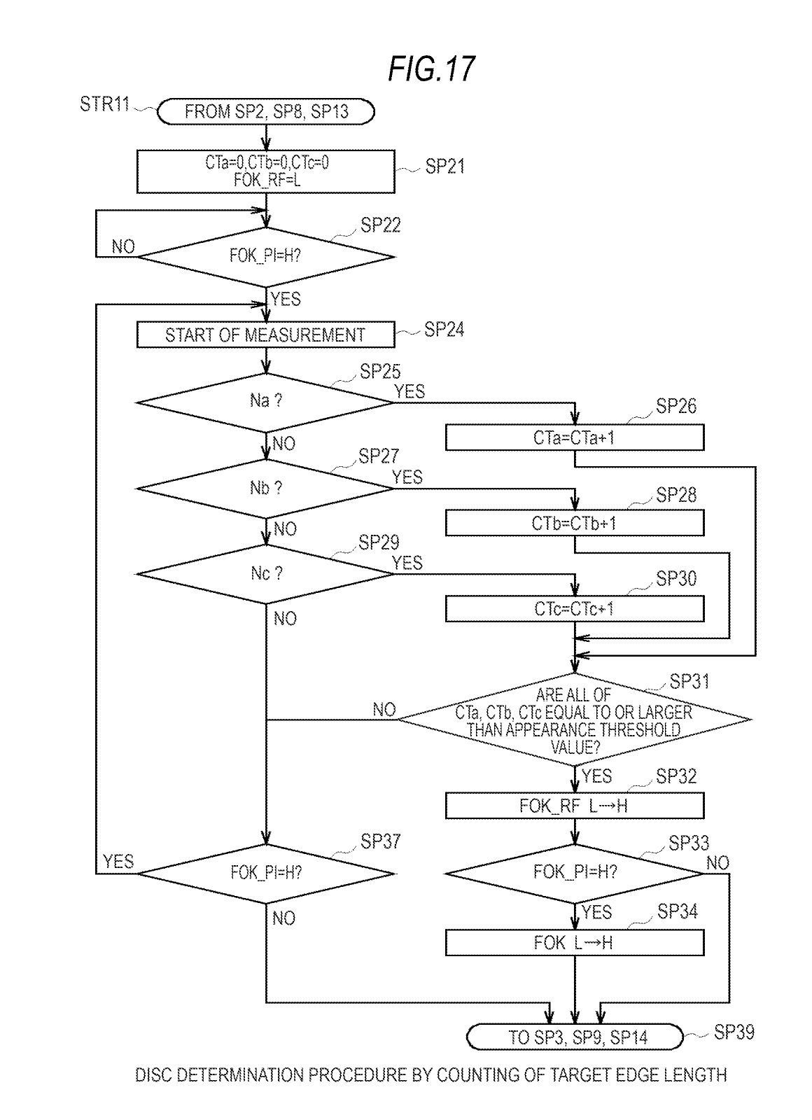

In step SP53, the control unit 2 moves to subroutine SRT11 (FIG. 17). When disc determination processing is executed using a target edge length selected from edge lengths not equal to those of other types of optical discs 100 in subroutine SRT11, the control unit 2 moves to the next step SP54.

In step SP54, the control unit 2 determines whether or not the recording surface check signal FOK has risen to a ‘High’ level in the disc determination processing. When a positive result is obtained, the control unit 2 moves to the next step SP55.

In step SP55, the control unit 2 recognizes that a BD recording surface has been detected from the unknown disc 100x, moving to the next step SP57.

On the other hand, when a negative result is obtained in step SP54, it means that a BD recording surface has not been detected from the unknown disc 100x. In this case, the control unit 2 moves to the next step SP56.

In step SP56, the control unit 2 determines whether or not the objective lens 7 has moved up to the DVD switching position. When a negative result is obtained, the control unit 2 returns to step SP53 to continue the disc determination processing because the objective lens 7 may not have reached the BD recording surface yet.

On the other hand, when a positive result is obtained in step SP56, the control unit 2 moves to the next step SP57 because there is no possibility that the BD recording surface will exist.

In step SP57, the control unit 2 switches a light beam illuminated to the unknown disc 100x to the DVD light beam Ld in a state where the objective lens 7 is moved maintaining the BD rotation number, moving to the next step SP58.

In step SP58, the control unit 2 moves to subroutine SRT11 (FIG. 17). When disc determination processing is executed using a target threshold range corresponding to the DVD recording surface, the control unit 2 moves to the next step SP59.

In step SP59, the control unit 2 determines whether or not the recording surface check signal FOK has risen to a ‘High’ level in the disc determination processing. When a positive result is obtained, the control unit 2 moves to the next step SP60.

In step SP60, the control unit 2 recognizes that a DVD recording surface has been detected from the unknown disc 100x, moving to the next step SP62.

On the other hand, when a negative result is obtained in step SP59, it means that a DVD recording surface has not been detected from the unknown disc 100x. In this case, the control unit 2 moves to the next step SP61.

In step SP61, the control unit 2 determines whether or not the objective lens 7 has moved up to the CD switching position. When a negative result is obtained, the control unit 2 returns to step SP58 to continue the disc determination processing because the objective lens 7 may not have reached the DVD recording surface yet.

On the other hand, when a positive result is obtained in step SP61, the control unit 2 moves to the next step SP62 because there is no possibility that the DVD recording surface will exist.

In step SP62, the control unit 2 switches a light beam illuminated to the unknown disc 100x to the CD light beam Lc in a state where the objective lens 7 is moved maintaining the BD rotation number, moving to the next step SP63.

In step SP63, the control unit 2 moves to subroutine SRT11 (FIG. 17). When disc determination processing is executed using a target threshold range corresponding to the CD recording surface, the control unit 2 moves to the next step SP64.

In step SP64, the control unit 2 determines whether or not the recording surface check signal FOK has risen to a ‘High’ level in the disc determination processing. When a positive result is obtained, the control unit 2 moves to the next step SP65.

In step SP65, the control unit 2 recognizes that a CD recording surface has been detected from the unknown disc 100x, moving to the next step SP67.

On the other hand, when a negative result is obtained in step SP64, it means that a CD recording surface has not been detected from the unknown disc 100x. In this case, the control unit 2 moves to the next step SP66.

In step SP66, the control unit 2 determines whether or not the objective lens 7 has moved up to the stop position. When a negative result is obtained, the control unit 2 returns to step SP63 to continue the disc determination processing because the objective lens 7 may not have reached the CD recording surface yet.

On the other hand, when a positive result is obtained in step SP66, the control unit 2 moves to the next step SP67 because there is no possibility that the CD recording surface will exist.

In step SP67, when the control unit 2 determines the type of the optical disc from the type of the detected signal recording surface, the control unit 2 moves to end step to finish the processing.

### (4-4-2) Focus Control Start Procedure

Next, a focus control start procedure RT3 executed according to a focus control start program will be described using a flow chart shown in FIG. 22.

The control unit 2 of the optical disc apparatus 51 starts the focus control start procedure RT3, for example, when a request signal instructing to execute recording or reproduction of information is supplied, and moves to step SP71.

In step SP71, the control unit 2 moves to subroutine SRT11 (FIG. 17). When disc determination processing is executed using a target threshold range corresponding to a determination target recording surface on which reproduction or recording is to be performed, the control unit 2 moves to the next step SP73.

In step SP73, the control unit 2 determines whether or not the recording surface check signal FOK has risen in the disc determination processing. When a positive result is obtained here, it means that the focal point of a light beam exists near the determination target recording surface. Accordingly, in this case, the control unit 2 moves to the next step SP74.

On the other hand, when a negative result is obtained, it means that the focal point of a light beam does not exist near the determination target recording surface. In this case, the control unit 2 moves to step SP72 to continue the disc determination processing.

In step SP74, when the control unit 2 detects that the focal point of a light beam has been almost formed on the determination target recording surface, the control unit 2 starts a focus control. Then, the control unit 2 moves to the end step to finish the focus control start procedure RT3.

### (4-5) Operations and Effects

In the above-described configuration, the optical disc apparatus 51 detects all signal recording layers of the unknown disc 100x by moving the objective lens 7 in the approaching direction from the most distant position to the stop position at a time.

In this case, the optical disc apparatus 51 determines that the unknown disc 100x is the BD media 100b when only a BD recording surface is detected from the unknown disc 100x. The optical disc apparatus 51 determines that the unknown disc 100x is the DVD media 100d when only a DVD recording surface is detected from the unknown disc 100x.

The optical disc apparatus 51 determines that the unknown disc 100x is the CD media 100c when only a CD recording surface is detected from the unknown disc 100x. In addition, when a BD recording surface, a DVD recording surface, and a CD recording surface are detected from the unknown disc 100x, the optical disc apparatus 51 determines that the unknown disc 100 is the hybrid media 100h as a fourth optical disc having a BD recording surface, a DVD recording surface, and a CD recording surface.

Here, in the hybrid media 100h, since the number of signal recording surfaces increases, a larger number of fake patterns Pf are generated in the focus error signal SFE or the pull-in signal SPI at the time of a search operation and the waveform is more complicated than that in the CD media 100c. As a result, when the unknown disc 100h is the hybrid media 100h, the determination becomes difficult. In this case, in a known optical disc apparatus, it is difficult to detect a desired signal recording surface. Accordingly, it also becomes difficult to start a focus control with respect to a desired signal recording layer.

Generally, in the hybrid media 100h, distortion, thickness unevenness, and the like are large and a variation in position of a signal recording surface is large. For this reason, even in a known optical disc apparatus that uses an optical pickup (that is, an optical pickup using a plurality of single focus lenses as objective lenses) in which the fake pattern Pf does not appear at the time of a search operation, the same signal recording surface may be detected twice when rotating the hybrid media 100h.

Accordingly, in a known optical disc apparatus, since it is difficult to correctly detect a signal recording surface of the hybrid media 100h only by time control (that is, detection of waveform of the focus error signal SFE or the pull-in signal SPI), there has been a case in which a focus control is erroneously started for different signal recording layers.

In the optical disc apparatus 51, a signal recording surface can be correctly detected by checking the size of the recording mark RM, which is formed on the signal recording surface, on the basis of the reproduction signal SRF. Accordingly, each signal recording layer can be detected correctly. As a result, in the optical disc apparatus 51, it is possible to correctly determine that the unknown disc 100x is the hybrid media 100h.

Furthermore, in the optical disc apparatus 51, the focus control is started for a desired signal recording layer in the hybrid media 100h after checking that it is a desired signal recording surface on the basis of the reproduction signal SRF. Accordingly, the focus control can be started appropriately.

Furthermore, the optical disc apparatus 51 rotates the unknown disc 100x with the BD rotation number as the predetermined number of rotations when illuminating the BD light beam Lb, the DVD light beam Ld, and the CD light beam Lc to the unknown disc 100h in order to determine the type of the unknown disc 100x.

Accordingly, since the optical disc apparatus 51 does not need to change the number of rotations according to a light beam illuminated to the unknown disc 100x, the search operation can be quickly executed without wasting the time for which the number of rotations becomes stabilized, compared with a case where the number of rotations is changed.

In the above-described configuration, the optical disc apparatus 51 moves the objective lens 7 in the approaching direction from the most distant position to the stop position at a time and detects the type of the unknown disc 100x on the basis of the detected signal recording surface. Accordingly, the optical disc apparatus 51 can also detect the hybrid media 100h, which is difficult to be determined, correctly.

### (4-6) Other Embodiments

Furthermore, in the third embodiment, the case where the disc determination processing is executed according to subroutine SRT11 has been described. However, the present invention is not limited thereto. For example, the disc determination processing may also be executed according to subroutine SRT12. In this case, the optical disc apparatus moves to step SP81 of subroutine SRT12 in steps SP53, SP58, and SP63 of the media type determination procedure RT2 and step SP72 of the focus control start procedure RT3. In addition, when the subroutine SRT12 ends, the optical disc apparatus returns to steps SP54, SP59, and SP64 of the media type determination procedure RT2 and step SP73 of the focus control start procedure RT3.

In the media type determination procedure RT2, a detection threshold range to be set is different from that in the second embodiment since the unknown disc 100x is rotated with the BD rotation number. That is, the BD rotation number (normal speed) is equivalent to 1.4 times the DVD rotation number and 2.05 times the CD rotation number. Accordingly, edge distance average values of the BD media 100b, the DVD media 100d, and the CD media 100c become 51.48 [nsec], 129.5 [nsec], and 551.0 [nsec], respectively.

Here, in case of measuring a detected edge number for 50 [μsec] for which information corresponding to one sink frame can be reproduced in the BD media 100b like the second embodiment, the number of reference edges detected from the BD media 10b, the DVD media 10d, and the CD media 100c becomes 971, 386, and 91, respectively, and the number of reference edges of the CD media 100c becomes small. In addition, 40.652 [μsec] is required to reproduce information of one sink frame from the DVD media 100d (1.4×), and 66.368 [μsec] is required to reproduce information of one sink frame from the CD media 100c (2.05×).

For this reason, in the optical disc apparatus, in case of measuring a detected edge number in a state where the unit time is set to 50 [μsec], an increase of error is assumed only for the CD media 100c and values obtained by increase and decrease of, for example, ±20% with respect to the number of reference edges are set as a detection threshold range. Moreover, for the BD media 100b and the DVD media 100d, values obtained by increase and decrease of, for example, ±10% with respect to the number of reference edges are set as a detection threshold range similar to the second embodiment. In this case, the detection threshold range becomes 874 to 1097 for the BD media 100b, 347 to 425 for the DVD media 100d, and 73 to 109 for the CD media 100c. In addition, it is needless to say that the unit time may be set to a time for which information of one sink frame can be reproduced in the CD media 100c (2.05×).

Furthermore, in the third embodiment, the case where the optical disc apparatus 51 executes both the media type determination procedure RT2 and the focus control start procedure RT3 has been described. However, the present invention is not limited thereto. In the third embodiment of the present invention, at least one of the media type determination procedure RT2 and the focus control start procedure RT3 may be executed.

Furthermore, in the third embodiment, the case where the objective lens 7 is moved at the fixed moving speed has been described. However, the present invention is not limited thereto. In the third embodiment of the present invention, the objective lens 7 may be moved at an arbitrary moving speed. For example, the objective lens 7 may be moved slowly only when the measurement timing signal FOK_PI is ‘High’. Accordingly, since the objective lens 7 can be moved slowly near the signal recording surface, disc determination processing can be correctly executed with a sufficient time.

Furthermore, in the third embodiment, the case where signal recording surfaces are detected from the BD media 100b, the DVD media 100d, the CD medium 100c, and the hybrid media 100h has been described. However, the present invention is not limited thereto. In the third embodiment of the present invention, signal recording surfaces can be detected from all types of optical discs 100 each having at least one of various kinds of signal recording surfaces.

Furthermore, in the third embodiment, the case where the unknown disc 100x is rotated with the BD rotation number has been described. However, the present invention is not limited thereto. In the third embodiment of the present invention, the unknown disc 100x may also be rotated with the DVD rotation number or the CD rotation number, for example. The number of rotations is not limited if it is the fixed number of rotations.

In addition, the configurations in the first, second, and third embodiments described above may be combined appropriately.

The present invention may be utilized for optical disc apparatuses corresponding to a plurality of types of optical discs.

The present application contains subject matter related to that disclosed in Japanese Priority Patent Application JP 2008-179257 filed in the Japan Patent Office on Jul. 9, 2008, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An optical disc apparatus comprising:
an objective lens that condenses a first light beam, which is emitted from a light source and corresponds to a first optical disc, and that illuminates the first light beam to an unknown disc whose type is unknown;
a driving section that drives the objective lens in a focus direction approaching or becoming distant from the unknown disc;
a rotation section that rotates the unknown disc;
a signal processing section that generates a first reproduction signal indicating a total amount of a first returning light beam generated by reflection of the first light beam from the unknown disc; and
a detecting section that detects a first signal recording surface, which corresponds to the first optical disc, from the unknown disc on the basis of the first reproduction signal.

2. The optical disc apparatus according to claim 1, further comprising:
a focus control start section that when the first signal recording surface is detected by the detecting section before a focal point of the first light beam reaches the first signal recording surface, detects that the focal point of the first light beam has been formed on the first signal recording surface and starts a control in the focus direction of the objective lens.

3. The optical disc apparatus according to claim 1,
wherein the detecting section detects the first signal recording surface on the basis of a switching interval at which a signal level of the first reproduction signal is switched between a ‘Low’ level and a ‘High’ level.

4. The optical disc apparatus according to claim 3,
wherein the detecting section detects the first signal recording surface when a switching interval corresponding to the length of a recording mark, which is to be formed on the first signal recording surface, has been detected a number of times equal to or larger than a predetermined appearance threshold value.

5. The optical disc apparatus according to claim 4,
wherein the detecting section detects the first signal recording surface when all of the plurality of switching intervals are detected a number of times equal to or larger than the predetermined appearance threshold value.

6. The optical disc apparatus according to claim 1,
wherein the detecting section detects the first signal recording surface on the basis of an average frequency of the first reproduction signal.

7. The optical disc apparatus according to claim 6,
wherein the detecting section detects the first signal recording surface when the number of switching timing, at which a signal level of the reproduction signal detected in a predetermined unit time is switched between a ‘Low’ level and a ‘High’ level, is within a predetermined detection threshold range.

8. The optical disc apparatus according to claim 1, further comprising:
a determining section that determines that the unknown disc is the first optical disc when the first signal recording surface has been detected from the unknown disc.

9. The optical disc apparatus according to claim 1,
wherein the objective lens condenses a second light beam corresponding to a second optical disc and illuminates the second light beam to the unknown disc,
the signal processing section generates a second reproduction signal indicating a total amount of a second returning light beam generated by reflection of the second light beam from the unknown disc, and
the detecting section detects a second signal recording surface, which corresponds to the second optical disc and on which a recording mark with a different size from that of the first signal recording surface is formed, from the unknown disc on the basis of the second reproduction signal.

10. The optical disc apparatus according to claim 9, further comprising:
a determining section that determines that the unknown disc is the second optical disc when the second signal recording surface has been detected from the unknown disc.

11. The optical disc apparatus according to claim 8,
wherein the objective lens condenses a third light beam corresponding to a third optical disc and illuminates the third light beam to the unknown disc,
the signal processing section generates a third reproduction signal indicating a total amount of a third returning light beam generated by reflection of the third light beam from the unknown disc, and
the detecting section detects a third signal recording surface, which corresponds to the third optical disc and on which a recording mark with a different size from those of the first and second signal recording surfaces is formed, from the unknown disc on the basis of the third reproduction signal.

12. The optical disc apparatus according to claim 11, further comprising:
a determining section that determines that the unknown disc is the third optical disc when the third signal recording surface has been detected from the unknown disc.

13. The optical disc apparatus according to claim 11,
wherein the determining section determines that the unknown disc is the first optical disc when only the first signal recording surface has been detected from the unknown disc, determines that the unknown disc is the second optical disc when only the second signal recording surface has been detected from the unknown disc, determines that the unknown disc is the third optical disc when only the third signal recording surface has been detected from the unknown disc, and determines that the unknown disc is a fourth optical disc having the first, second, and third signal recording surfaces when the first, second, and third signal recording surfaces have been detected from the unknown disc.

14. The optical disc apparatus according to claim 8,
wherein the driving section moves the objective lens in only one direction, which becomes distant from the unknown disc or approaches the unknown disc, of the focus direction, and
the light source performs switching between the first and second light beams according to the position of the objective lens and illuminates the corresponding light beam to the unknown disc.

15. The optical disc apparatus according to claim 8,
wherein the driving section moves the objective lens in one direction, which becomes distant from the unknown disc or approaches the unknown disc, of the focus direction,
the light source illuminates the first light beam to the unknown disc,
the driving section moves the objective lens from a predetermined switching position toward the one direction by moving the objective lens in the other direction, and
the light source illuminates the second light beam from the switching position to the unknown disc.

16. The optical disc apparatus according to claim 11,
wherein the rotation section rotates the unknown disc with the first number of rotations corresponding to the first disc when the first light beam is illuminated to the unknown disc, rotates the unknown disc with the second number of rotations corresponding to the second disc when the second light beam is illuminated to the unknown disc, and rotates the unknown disc with the third number of rotations corresponding to the third disc when the third light beam is illuminated to the unknown disc.

17. The optical disc apparatus according to claim 11,
wherein the rotation section rotates the unknown disc with the predetermined number of rotations when the first, second, and third light beams are illuminated to the unknown disc.

18. The optical disc apparatus according to claim 8,
wherein the objective lens illuminates the first light beam to the first signal recording surface by condensing the first light beam at a first focal point and illuminates the second light beam to the second signal recording surface by condensing the second light beam at a second focal point.

19. The optical disc apparatus according to claim 8,
wherein the objective lens has a first objective lens for condensing the first light beam and a second objective lens for condensing the second light beam.

20. A signal recording surface detecting method, comprising the steps of:
performing focus search of rotating an unknown disc whose type is unknown, condensing a first light beam corresponding to a first optical disc and illuminating the first light beam to the unknown disc by the objective lens, and driving the objective lens in a focus direction approaching or becoming distant from the unknown disc;
performing signal processing for generating a first reproduction signal indicating a total amount of a first returning light beam generated by reflection of the light beam from the unknown disc; and
detecting a first signal recording surface, which corresponds to the first optical disc, from the unknown disc on the basis of the first reproduction signal.

21. An optical disc apparatus comprising:
an objective lens that condenses a light beam emitted from a light source and illuminates the light beam to an optical disc;
a driving section that drives the objective lens in a focus direction approaching or becoming distant from the optical disc;
a rotation section that rotates the optical disc;
a signal processing section that generates a reproduction signal indicating a total amount of a returning light beam generated by reflection of the light beam from the optical disc; and
a detecting section that detects a signal recording surface from the optical disc on the basis of the reproduction signal.

22. A signal recording surface detecting method, comprising the steps of:
performing focus search of rotating an optical disc, condensing a light beam emitted from a light source and illuminating the light beam to the optical disc, and changing a focal point of the light beam in a focus direction approaching or becoming distant from the optical disc;
performing signal processing for generating a reproduction signal indicating a total amount of a returning light beam generated by reflection of the light beam from the optical disc; and
detecting a signal recording surface from the optical disc on the basis of the reproduction signal.
